(19) United States
(12) Patent Application Publication
(10) Pub. No.: US 2026/0260877 A1
(43) Pub. Date: Sep. 3, 2026

(54) ORGANIC THIN FILM COATINGS FOR BATTERY MATERIALS

(71) Applicant: CORESHELL TECHNOLOGIES, INC., San Leandro, CA (US)

(72) Inventors: Sourav Roger Basu, El Cerrito, CA (US); Jonathan Tan, Oakland, CA (US); Matthew A. Kolaczkowski, Oakland, CA (US)

(21) Appl. No.: 19/489,196

(22) PCT Filed: May 31, 2024
(86) PCT No.: PCT/US2024/031975

§ 371 Date: Dec. 1, 2025

Related U.S. Application Data
(60) Provisional application No. 63/505,604, filed on Jun. 1, 2023.

(51) Int. Cl. H01M 4/36; H01M 4/04; H01M 10/0525

(52) U.S. Cl. CPC H01M 4/366; H01M 4/0404; H01M 10/0525

(57) ABSTRACT

Implementations are described herein that produce coatings of battery electrode materials. The coatings can include a number of layers with individual layers of the one or more layers comprising one or more organic compounds.

### CLAIM OF PRIORITY

This patent application claims the benefit of priority to U.S. patent application Ser. No. 63/505,604, filed Jun. 1, 2023, which is incorporated by reference herein in its entirety.

### FIELD OF THE INVENTION

One or more implementations relate to thin films of various organic materials, which, when deposited on the surface of lithium-ion battery materials, passivate their surfaces against degrading reactions during operation.

### BACKGROUND

Capacity fade in Lithium-Ion Batteries (LIBs) is the result of parasitic reactions that occur due to cell voltages outside of common electrolyte stability windows. In LIBs, such voltages are observed near full state-of-charge, where reductive breakdown of the electrolyte occurs on anode surfaces and oxidative breakdown of the electrolyte occurs on cathode surfaces. Additionally, in circumstances where charge and discharge rates are high, these voltage limits may be encountered at capacity values far from full charge or discharge. This is due to voltage drop from internal resistance experienced at high rates. The basic mechanism of breakdown includes gain or loss of electrons by the electrolyte to or from the electrode for oxidative or reductive processes, respectively.

### BRIEF DESCRIPTION OF THE DRAWINGS

FIG. 1 illustrates a framework to produce a coating on a battery electrode material that includes a number of individual layers having one or more organic compounds, in accordance with one or more examples.

FIG. 2 illustrates an additional framework to produce a coating on a battery electrode material that includes a number of repeating sets of individual layers having one or more organic compounds, in accordance with one or more examples.

FIG. 3 illustrates a coating of a battery electrode material, where the coating includes a number of individual layers formed from individual organic compounds, in accordance with one or more examples.

FIG. 4 illustrates an apparatus to deposit a number of layers of a coating including an organic compound on a battery electrode material, in accordance with one or more examples.

FIG. 5 illustrates a flow diagram of a process to deposit a number of layers of a coating including an organic compound on a battery electrode material, in accordance with one or more examples.

### DETAILED DESCRIPTION

In state-of-the-art Li-ion batteries, reduction reactions during the first few charging cycles result in a substantial consumption of lithium and formation of an “SEI” (Solid-Electrolyte-Interphase). Formation of a conformal and electrically insulating SEI can take place in order to limit substantial breakdown of electrolyte to only the first few cycles and to prevent continuous breakdown of electrolyte during subsequent cycles. Prevailing theory suggests that an electrically insulating SEI will prevent the transfer of electrons that occurs during either reduction or oxidation of electrolyte. However, post-mortem observations of the surfaces of battery electrodes that have been cycled on the order of hundreds to thousands of times conclude that SEI continues to form throughout the life of a battery. The continued formation of SEI is a primary cause of capacity fade in Lithium-Ion batteries, and most likely occurs because the SEI is neither perfectly electrically insulating nor has the mechanical integrity to withstand thousands of cycles. The composition of SEI-a mosaic of various Lithium-containing fluorides, oxides, carbonates and other metalorganics-cannot be expected to be devoid of the sorts of defects such as grain boundaries, pinholes, unsaturated bonds, etc. that are common in electronic failures of other poor dielectric materials.

To alleviate the problems that occur with respect to electrochemically-grown SEI, a thin-film coating comprising rationally-chosen materials can be deposited on the surface of battery electrodes—in effect, providing an “artificial SEI”—that could yield a more resilient barrier against electrochemical degradation and reduce capacity fade during cycling. In particular, numerous studies have focused on the employment of thin-film nanolayers composed of inorganic materials such as oxides, fluorides and phosphates applied directly to battery material surfaces. However, while some inorganic coating materials may provide improved electrochemical resilience against degrading reactions, these coatings may be unable to mechanically withstand the repeated volumetric expansion and contraction of the underlying battery electrode during cycling. For example, state-of-the-art lithium-ion electrode materials such as graphite and LiNiₓMn_{y}Co_{z}O₂, expand and contract volumetrically by as much as 10% during charging and discharging. “Next-generation” lithium-ion “conversion” anode materials such as Sn and Si are known to expand and contract volumetrically by as much has 300% during cycling. Inorganic coating materials, which possess low tensile strain limits at fracture, are typically unable to accommodate this range of volumetric expansion before failing mechanically.

Implementations are described herein that produce coatings that are both highly electrochemically and mechanically resilient in order to serve as improved artificial SEI coatings in lithium-ion batteries. For example, a number of organic materials, such as thin-film polymers, possess a wide window of electrochemical stability while also being mechanically resilient against deformation. Consequently, such materials can be effectively employed as artificial SEI in lithium-ion batteries.

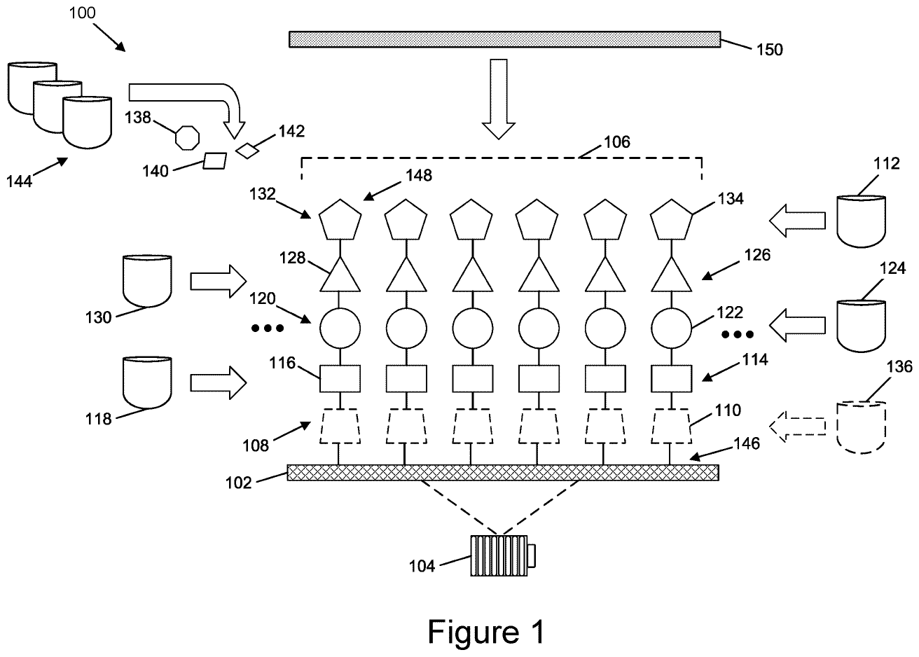

FIG. 1 illustrates a framework 100 to produce a coating on a battery electrode material that includes a number of individual layers having one or more organic compounds, in accordance with one or more examples. The framework 100 can include a substrate 102 of a battery 104. In one or more examples, the substrate 102 can comprise at least one layer of the battery 104. For example, the substrate 102 can comprise at least a portion of an electrode of the battery 104. In one or more examples, the substrate 102 can comprise at least a portion of a cathode of the battery 104. In one or more additional examples, the substrate 102 can comprise at least a portion of an anode of the battery 104. In scenarios where the substrate 102 comprises at least a portion of an anode, the substrate 102 can include one or more carbon-containing materials. To illustrate, the substrate 102 can be comprised, at least partially, of graphite. In one or more illustrative examples, the substrate 102 can include a number of layers, such as a metallic layer with a carbon-containing layer formed over the metallic layer. In various examples, the metallic layer can comprise at least one of copper, aluminum, tin, magnesium, silver, or one or more alloys thereof. Additionally, in situations where the substrate 102 comprises at least a portion of an anode of the battery 104, the substrate 102 can include one or more silicon-containing materials.

A coating 106 can be formed over the substrate 102. The coating 106 can comprise a number of layers. In various examples, individual layers of the number of layers can include one or more organic materials. In one or more examples, individual layers of the coating 106 can be deposited onto the substrate 102 by exposing the substrate 102 to one or more solutions. In at least some examples, the coating 106 can form a film over the substrate 102.

In one or more examples, an intermediate layer 108 can, optionally, be formed between the substrate 102 and the coating 106. The intermediate layer 108 can comprise an intermediate layer organic compound 110. In one or more illustrative examples, the intermediate layer 108 can include one or more functional groups to anchor one or more layers of the coating 106 to the substrate 102. The intermediate layer 108 can be deposited onto the substrate 102 using an intermediate layer solution 136. The intermediate layer solution 136 can include an amount of at least one of the intermediate layer organic compound 110 or a precursor of the intermediate layer organic compound 110.

The intermediate layer 108 can include one or more compounds that individually include a first functional group to attach to the substrate 102 and a second functional group to attach to additional compounds included in the coating 106. In at least some examples, the first functional group can covalently bond with one or more compounds of the substrate 102. In one or more additional examples, the first functional group can attach non-covalently with one or more compounds of the substrate 102. For example, the first functional group can form ionic bonding with one or more compounds of the substrate 102.

The intermediate layer 108 can include an organic compound comprised of an alkyl chain having no greater than 12 carbon atoms, no greater than 10 carbon atoms, no greater than 8 carbon atoms, or no greater than 6 carbon atoms. In one or more examples, the intermediate layer 108 can include an organic compound comprised of an alkyl chain having from 1 carbon atom to 12 carbon atoms, from 2 carbon atoms to 10 carbon atoms, from 4 carbon atoms to 8 carbon atoms, for from 2 carbon atoms to 6 carbon atoms. In one or more additional examples, the first functional group to attach to the substrate 102 can include a carboxylate group, a phosphate group, a halide group, halosilane, or a silicon alkoxide. In one or more further examples, the second functional group to attach to additional compounds included in the coating 106 can include an alcohol, an amine, a thiol, an anhydride, or an isocyanate. In one or more illustrative examples, the intermediate layer 108 can include 3-hydroxypropanoic acid, 2-hydroxyethyl dihydrogen phosphate, hydroxymethyltriethoxysilane, b-alanine, 2-aminoethyl dihydrogen phosphate, (3-aminopropyl)triethoxysilane (APTES), 4-(triethoxysilyl)aniline, (3-triethoxysilyl)propylsuccinic anhydride, 3-isocyanatopropyltriethoxysilane, 3-mercaptopropanoic acid, 2-mercaptoethyl dihydrogen phosphate, or (3-mercaptopropyl)trimethoxysilane (MPTES).

The coating 106 can include a number of layers. Individual layers of the coating 106 can include one or more organic compounds. The individual layers of the coating 106 can be formed by depositing a solution onto one or more previous layers that includes at least one of a given organic compound to be included in the layer or a precursor of the given organic compound. In the illustrative example of FIG. 1, the coating 106 includes a first organic compound layer 114 that is comprised of one or more first organic compounds 116. The first organic compound layer 114 can be formed by depositing a first organic compound layer solution 118 onto the intermediate layer 108 or, in the absence of an intermediate layer 108, directly onto the substrate 102. The first organic compound layer solution 118 can include at least one of the one or more first organic compound 116 or one or more precursors of the one or more first organic compounds 116.

The coating 106 can also include a second organic compound layer 120 that is comprised of one or more second organic compounds 122. The second organic compound layer 120 can be formed by depositing a second layer solution 124 onto the first organic compound layer 114. The second layer solution 124 can include at least one of the one or more second organic compounds 122 or one or more precursors of the one or more second organic compounds 122. In addition, the coating 106 can include a third organic compound layer 126 that is comprised of one or more third organic compounds 128. The third organic compound layer 126 can be formed by depositing a third layer solution 130 onto the second organic compound layer 120. The third layer solution 130 can include at least one of the one or more third organic compounds 128 or one or more precursors of the one or more third organic compounds 128. Further, the coating 106 can include a fourth organic compound layer 132 that is comprised of one or more fourth organic compounds 134. The fourth organic compound layer 132 can be formed by depositing a fourth organic compound layer solution 136 onto the third organic compound layer 126. The fourth organic compound layer solution 136 can include at least one of the one or more fourth organic compounds 134 or one or more precursors of the one or more fourth organic compounds 134.

In one or more examples, at least some of the layers of the coating 106 can include an organic compound that is different from the organic compound included in one or more additional layers of the coating 106. To illustrate, the one or more first organic compounds 116 can be different from at least one of the one or more second organic compounds 122, the one or more third organic compounds 128, or the one or more fourth organic compounds 134. Additionally, the one or more second organic compounds 122 can be different from at least one of the one or more first organic compounds 116, the one or more third organic compounds 128, or the one or more fourth organic compounds 134. Further, the one or more third organic compounds 128 can be different from at least one of the one or more first organic compounds 116, the one or more second organic compounds 122, or the one or more fourth organic compounds 134. In various examples, the one or more fourth organic compounds 134 can be different from at least one of the one or more first organic compounds 116, the one or more second organic compounds 122, or the one or more third organic compounds 128. In still other examples, the layers 114, 120, 126, 132 can include a same organic compound or a same group of organic compounds.

In one or more additional examples, layers of the coating 106 can be arranged according to a pattern according to one or more organic compounds included in the individual layers of the coating 106. For example, the coating 106 can include a pattern where the first organic compound layer 114 and the third organic compound layer 126 include one or more organic compounds that are the same and the second organic compound layer 120 and the fourth organic compound layer 132 include one or more additional organic compounds that are the same and are different from the one or more organic compounds of the first organic compound layer 114 and the third organic compound layer 126. In one or more additional examples, the coating 106 can include a pattern where the first organic compound layer 114 and the second organic compound layer 120 include one or more organic compounds that are the same and the third organic compound layer 126 and the fourth organic compound layer 132 include one or more additional organic compounds that are the same and different from the one or more organic compounds of the first organic compound layer 114 and the second organic compound layer 120.

The one or more organic compounds included in the layers 114, 120, 126, 132 can include a backbone moiety and at least two functional groups. In one or more examples, the backbone moiety can include an alkyl chain having no greater than 8 carbon atoms. In one or more additional examples, the backbone moiety can include a cyclic aromatic hydrocarbon group. In one or more further examples, the backbone moiety can include a fluorinated alkyl chain having no greater than 8 carbon atoms. In still other examples, the backbone moiety can include one or more ether groups. The backbone moiety can also include a polymeric compound including a number of monomer units. The monomer units of the polymeric compound can include no greater than 12 carbon atoms, no greater than 10 carbon atoms, no greater than 8 carbon atoms, no greater than 6 carbon atoms, or no greater than 4 carbon atoms. In various examples, the monomer units of the polymeric compound can include from 1 to 12 carbon atoms, from 2 to 10 carbon atoms, from 4 to 8 carbon atoms, or from 2 to 6 carbon atoms. Additionally, the polymeric compound can have a molecular weight no greater than one million Daltons (Da), no greater than 800,000 Da, no greater than 600,000 Da, no greater than 500,000 Da, no greater than 300,000 Da, no greater than 250,000 Da, no greater than 200,000 Da, no greater than 150,000 Da, no greater than 100,000 Da, no greater than 75,000 Da, no greater than 50,000 Da, or no greater than 25,000 Da. In one or more illustrative examples, the polymeric compound can have a molecular weight from about 10,000 Da to about 1,000,000 Da, from about 25,000 Da to about 500,000 Da, from about 100,000 Da to about 300,000 Da, from about 50,000 Da to about 250,000 Da, or from about 10,000 Da to about 100,000 Da.

In one or more examples, the at least two functional groups of the organic compounds included in the layers 114, 120, 126, 132 can include at least two electrophilic functional groups, at least three electrophilic functional groups, at least four electrophilic functional groups, at least five electrophilic functional groups, or at least six electrophilic functional groups. Additionally, the at least two functional groups of the organic compounds included in the layers 114, 120, 126, 132 can include a least two nucleophilic groups, at least three nucleophilic groups, at least four nucleophilic groups, at least five nucleophilic groups, or at least six nucleophilic groups. In one or more illustrative examples, in scenarios where the organic compounds included in the layers 114, 120, 126, 132 include at least two electrophilic functional groups, the at least two electrophilic functional groups can include a carbodiimide group, an isothiocyanate group, an isocyanate group, an acyl halide group, an ester group, anhydride group, chloroformate ester, ammonium, a phosphonium group, or one or more combinations thereof. In one or more additional illustrative examples, in instances where the organic compounds included in the layers 114, 120, 126, 132 include at least two nucleophilic functional groups, the at least two nucleophilic functional groups can include an amine, an alcohol, a thiol, a carboxylate, a phosphonate, a sulfonate, or one or more combinations thereof. In various examples, the at least two functional groups of the organic compounds included in the layers 114, 120, 126, 132 can be the same. In at least some examples, at least some of the at least two functional groups of the organic compounds included in the layers 114, 120, 126, 132 can be different.

In various examples, the molecules included in at least a portion of the layers 114, 120, 126, 132 can be attached through covalent bonding. In one or more additional examples, the molecules included in at least a portion of the layers 114, 120, 126, 132 can be attached through non-covalent bonding. For example, the molecules included in at least a portion of the layers 114, 120, 126, 132 can be attached through acid-base reaction. In one or more further examples, the molecules included in at least a portion of the layers 114, 120, 126, 132 can be attached through salt metathesis.

In one or more examples, a number of capping compounds can be added to the coating 106. The one or more capping compounds can be added to the coating 106 to inhibit reaction of the functional groups of the one or more organic compounds included in the layers 114, 120, 126, 132. In the illustrative example of FIG. 1, a first capping compound 138, a second capping compound 140, and a third capping compound 142 can be added to one or more layers of the coating 106. The capping compounds 138, 140, 142 can be added to the coating 106 by depositing one or more capping solutions 144 on one or more layers of the coating 106. In various examples, the one or more capping solutions 144 can include a first capping solution that corresponds to the first capping compound 138, a second capping solution that corresponds to the second capping compound 140, and a third capping solution that corresponds to the third capping compound 142.

In at least some examples, the capping solutions 144 can be deposited onto one or more layers of the coating 106 prior to the coating being fully formed. For example, after forming the first organic compound layer 114 by depositing the first organic compound layer solution 118, the second layer solution 124 can be deposited onto the first organic compound layer 114. A first capping layer solution 144 can then be deposited to at least one of reduce or eliminate reactions by molecules of the one or more first organic compounds 116 included in the first organic compound layer 114. In various examples, the first capping layer solution 144 can include one or more capping compounds 138, 140, 142 that are configured to react with the one or more first organic compounds 116 and are less likely to react with the one or more second organic compounds 122 to enable the one or more second organic compounds 122 to bond with one or more additional layers of the coating 106. Continuing with the above example, after the second organic compound layer 120 has been formed by depositing the second organic compound layer solution 124, the third organic compound layer solution 130 can be deposited onto the second organic compound layer 120 to form the third organic compound layer 126. A second capping solution 144 can be deposited to at least one of reduce or eliminate reactions by molecules of the one or more second organic compounds 122 included in the second organic compound layer 120. In one or more examples, the second capping solution 144 can include one or more capping compounds 138, 140, 142 that are configured to react with the one or more second organic compounds 122 and are less likely to react with the one or more third organic compounds 128 to enable the one or more third organic compounds 128 to bond with one or more additional layers of the coating 106. The one or more capping compounds 138, 140, 142 included in the second capping solution can be different from the one or more capping compounds 138, 140, 142 included in the first capping solution.

Further, after the third organic compound layer 126 has been formed by depositing the third organic compound layer solution 130, the fourth organic compound layer solution 136 can be deposited onto the third organic compound layer 126 to form the fourth organic compound layer 132. A third capping solution 144 can be deposited to at least one of reduce or eliminate reactions by molecules of the one or more third organic compounds 128 included in the third organic compound layer 126. In one or more examples, the third capping solution 144 can include one or more capping compounds 138, 140, 142 that are configured to react with the one or more third organic compounds 128 and are less likely to react with the one or more fourth organic compounds 134 to enable the one or more fourth organic compounds 134 to bond with one or more additional layers of the coating 106. The one or more capping compounds 138, 140, 142 included in the third capping solution can be different from the one or more capping compounds 138, 140, 142 included in the first capping solution and the second capping solution.

In one or more additional examples, the one or more capping solutions 144 can be deposited at different times throughout the process of forming the coating 106. For example, the one or more capping solutions 144 can be deposited after the formation of at least one of the first organic compound layer 114, the second organic compound layer 120, the third organic compound layer 126, or the fourth organic compound layer 132. In scenarios where the coating 106 includes an intermediate layer 108, the one or more capping solutions 144 can be deposited after formation of the intermediate layer 108.

The capping compounds 138, 140, 142 can include a backbone moiety and no greater than three functional groups. In at least some examples, the capping compounds 138, 140, 142 can include no greater than two functional groups. In various examples, the capping compounds 138, 140, 142 can include no greater than one functional group. In one or more examples, the backbone moiety of the capping compounds 138, 140, 142 can include an alkyl chain having no greater than 8 carbon atoms. In addition, the backbone moiety of the capping compounds 138, 140, 142 can include a cyclic aromatic hydrocarbon group. In one or more further examples, the backbone moiety of the capping compounds 138, 140, 142 can include a fluorinated alkyl chain having no greater than 8 carbon atoms. In still other examples, the backbone moiety of the capping compounds 138, 140, 142 can include one or more ether groups.

Additionally, the one or more functional groups of the capping compounds 138, 140, 142 can include one or more nucleophilic functional groups. The one or more functional groups of the capping compounds 138, 140, 142 can also include one or more electrophilic functional groups. In one or more examples, the one or more functional groups of the capping compounds 138, 140, 142 can include a hydroxyl group, an acyl halide group, an ether group, or an acyl chloride group. In one or more illustrative examples, the capping compounds 138, 140, 142 can include benzylamine; propylamine; 2,2,2-trifluoroethyl amine; 2-methoxyethane-I-amine; phenol; benzyl alcohol; propanol; 2,2,2-trifluoroethanol; ethylene glycol monoethyl ether; benzoyl chloride; butyryl chloride; trifluoropropionyl chloride; 1-isocyanato-2-methoxyethane; furfuryl isocyanate; phenyl isocyanate; benzyl isocyanate; naphthyl isocyanate; cyclohexyl isocyanate; butyl isocyanate; 3,5-bis(trifluoromethyl)phenylisocyanate; 4-(trifluoromethyl)phenyl isocyanate; pentafluorophenyl isocyanate; mPEG-isocyanate; phenyl chloroformate; benzyl chloroformate; pentafluorobenzyl chloroformate; Fmoc-chloride; methyl chloroformate; butyl chloroformate; propyl chloroformate; pentyl chloroformate; 2,2,2-trifluoroethyl chloroformate; 2-methoxyethyl chloroformate; vinyl chloroformate, allyl chloroformate; or propargyl chloroformate. Further, although the illustrative example of FIG. 1 shows that three capping compounds are added to the coating 106, in other examples, fewer capping compounds can be added to the coating 106 or a greater number of capping compounds can be added to the coating 106.

The coating 106 can be formed such that individual layers 108, 114, 120, 126, 132 include a number of instances of a given organic compound arranged substantially parallel in relation to a surface 146 of the substrate 102. For example, the first organic compound layer 114 can include a number of instances of the first organic compound 116 arranged substantially parallel in relation to the surface 146 of the substrate 102. Additionally, the second organic compound layer 120 can include a number of instances of the second organic compound 122 arranged substantially parallel in relation to the surface 146 of the substrate 102. Further, the third organic compound layer 126 can include a number of instances of the third organic compound 128 arranged substantially parallel in relation to the surface 146 of the substrate 102. The fourth organic compound layer 132 can include a number of instances of the fourth organic compound 134 arranged substantially parallel in relation to the surface 146 of the substrate 102. In scenarios where the coating 106 includes an intermediate layer 108, the intermediate layer 108 can include a number of instances of the intermediate organic compound 110 arranged substantially parallel in relation to the surface 146 of the substrate 102.

In various examples, the organic compounds included in the layers 108, 114, 120, 126, 132 can form chains that extend away from the surface 146 of the substrate 102. For example, the coating 106 can include a number of chains, such as chain 148, that are comprised of individual molecules of the layers 108, 114, 120, 126, 132. To illustrate, the chain 148 can include a first molecule of the first organic compound 116 of the first organic compound layer 114 coupled to a second molecule of the second organic compound 122 of the second organic compound layer 120. The chain 148 can also include a second molecule of the second organic compound 122 of the second organic compound layer 120 coupled to a third molecule of the third organic compound 128 of the third organic compound layer 126 and a fourth molecule of the fourth organic compound 134 of the fourth organic compound layer 132 coupled to a third molecule of the third organic compound 128 of the third organic compound layer 126. In scenarios where the coating 106 includes an intermediate layer 108, the chain 148 can include a molecule of the intermediate compound 110 coupled to the substrate 102 and coupled to a first molecule of the first organic compound 116 of the first organic compound layer 114.

In at least some examples, crosslinking can occur between chains of the coating 106. To illustrate, one or more molecules of the first chain 148 can bond to one or more molecules of adjacent chains. In various examples, molecules included in a same layer can bond between chains. For example, a first molecule of the first organic compound 116 of the first organic compound layer 114 included in the chain 148 can bond with another molecule of the first organic compound 116 of the first organic compound layer 114 in an adjacent chain. Molecules of the second organic compound 122 of the second organic compound layer 120, molecules of the third organic compound 128 of the third organic compound layer 126, and/or molecules of the fourth organic compound 134 of the fourth organic compound layer 132 can also bond across chains. Additionally, molecules included in different layers can bond between chains. In one or more illustrative examples, a first molecule of the first organic compound 116 of the first organic compound layer 114 in the first chain 148 can bond with at least one of a second molecule of the second organic compound 122 of the second organic compound layer 120, a third molecule of the third organic compound 128 of the third organic compound layer 126, or a fourth molecule of the fourth organic compound 134 of the fourth organic compound layer 132. In one or more additional illustrative examples, a second molecule of the second organic compound 122 of the second layer can bond with at least one of a third molecule of the third organic compound 128 of the third organic compound layer 126, or a fourth molecule of the fourth organic compound 134 of the fourth organic compound layer 132. In one or more further examples, a third molecule of the third organic compound 128 of the third organic compound layer 126 can bond with at least one of a fourth molecule of the fourth organic compound 134 of the fourth organic compound layer 132. In one or more examples, bonding can take place between molecules of at least one of the first organic compound layer 114, the second organic compound layer 120, the third organic compound layer 126, or the fourth organic compound layer 132 prior to one or more capping solutions 144 being deposited.

In one or more examples, individual chains formed from individual molecules of the layers 108, 114, 120, 126, 132 can comprise a polymeric compound having monomer units that include from 1 to 12 carbon atoms, from 2 to 10 carbon atoms, from 4 to 8 carbon atoms, or from 2 to 6 carbon atoms. In one or more illustrative examples, the individual chains can have a molecular weight from about 10,000 Da to about 1,000,000 Da, from about 25,000 Da to about 500,000 Da, from about 100,000 Da to about 300,000 Da, from about 50,000 Da to about 250,000 Da, or from about 10,000 Da to about 100,000 Da.

In various illustrative examples, at least one of the first organic compound 116, the second organic compound 122, the third organic compound 128, or the fourth organic compound 134 can include a polymeric compound. In these scenarios, crosslinking can take place between monomer units of the polymeric compound included in at least one of the first organic compound layer 114, the second organic compound layer 120, the third organic compound layer 126, or the fourth organic compound layer 132. In at least some examples, dendritic structures can be formed by the bonding between the monomer units of a polymeric compound comprising at least one of the first organic compound layer 114, the second organic compound layer 120, the third organic compound layer 126, or the fourth organic compound layer 132. In one or more examples, dendritic structures can be formed in situations where at least one of the first organic compound 116, the second organic compound 122, the third organic compound 128, or the fourth organic compound 134 comprise polyethyleneimine.

In one or more illustrative examples, the coating 106 can comprise at least one of phenylene diamine; melamine; 4,4′-oxydianiline; 4,4′-(1,4-phenylenediisopropylidene)bisaniline; emeraldine; leucoemeraldine; polypyrrole; poly(4-vinylpyridine); poly(4-vinylaniline); ethylene diamine; propylene diamine; diethylenetriamine; triethylenetetraamine; tetraethylenepentamine; pentaethylene hexamine; polyethyleneimine; polyallylamine; 3,5-bis(trifluoromethyl)phenylene-1,2-diamine; 2-(2-aminoethoxy)ethylamine; 2,2′-(ethylenedioxy)bis(ethylamine); 1,11-diamino-3,6,9-trioxaundecane; polyethyleneglycol amine terminated; hydroquinone; xylene-α,α′-diol; bisphenol P; bisphenol A; poly(4-vinylphenol); ethane-1,2-diol; propane-1,3-diol; glycerol; polyvinyl alcohol; polyallyl alcohol; 2,2,3,3-tetrafluoro-1,4-butanediol; hexafluoro-2,3-bis(trifluoromethyl)-2,3-butanediol; 1H,1H,8H,8H-perfluoro-3,6-dioxaoctane-1,8-diol; diethylene glycol; dipropylene glycol; triethylene glycol; polyethylene glycol; paraformaldehyde; polypropylene glycol; 1,3,4-thiadiazole-2,5-dithiol; benzene-1,4-dithiol; 1,4-benzenedimethanethiol; trithiocyanuric acid; biphenyl-4,4′-dithiol; 1,2-ethanethiol; 1,6-hexanedithiol; 1,11-undecanedithiol; trimethylolpropane tris(3-mercaptopropionate); pentaerythritol tetrakis(3-mercaptopropionate); 2,2′-thiodiethanethiol; tetra(ethylene glycol) dithiol; poly(ethylene glycol) dithiol; terephthaloyl chloride; trimesoyl chloride; oxalyl chloride; succinyl chloride; polyacryloyl chloride; polymethacryloyl chloride; tetrafluorosuccinyl chloride; tetrafluoroterephthaloyl chloride; 2,2′-oxydiacetyl chloride; toluene 2,4-diisocyanate; 4,4′-diphenylmethanediisocyanate; poly[(phenyl isocyanate)-co-formaldehyde; hexamethylene diisocyanate; 4,4′-methylenebis(cyclohexyl isocyanate); poly(hexamethylene diisocyanate); 4arm-PEG-isocyanate; poly(propylene glycol)-tolylene 2,4-diisocyanate terminated; 1,4-phenylene bis(chloroformate); bisphenol A bis(chloroformate); ethylenebis(chloroformate); di(ethylene glycol) bis(chloroformate); tri(ethylene glycol) bis(chloroformate); 1,4-phenylene diisothiocyanate; tolylene-2,4-diisothiocyanate; 4,4′-(diisothiocyanatodiphenylmethane; 4,4′-(methylenebis(2-chlorophenyl)diisothiocyanate; or butane-1,4-diisothiocyanate. In one or more additional illustrative examples, the coating 106 can comprise at least one of neutral, lithium salt, sodium salt, or potassium salt of at least one of poly(acrylic acid), poly(methacrylic acid), alginic acid, polyambic acid, carboxymethyl cellulose, carrageenan, poly(4-styrenesulfonic acid), or poly(4-vinylphenol). In one or more further illustrative examples, the coating 106 can comprise at least one of neutral, chloride salt, or fluoride salt of at least one of poly(diallyldimethylammonium chloride), chitosan, polyallylammonium hydrochloride, poly(4-vinylpyridine), or polyethyleneimine.

After formation of the coating 106, a terminal layer 150 can be formed over the coating 106. In one or more examples, the terminal layer 150 can include an additional layer of the battery 104. For example, the terminal layer 150 can include an additional layer of an anode of the battery 104 or an additional layer of a cathode of the battery 104. In at least some examples, the terminal layer 150 can include a capping layer comprised of at least one of the capping compounds 138, 140, 142. In situations where the terminal layer 150 includes a capping layer, one or more capping solutions 144 can be deposited on the coating 106 to inhibit reaction of the fourth organic compounds 134 of the fourth layer 132.

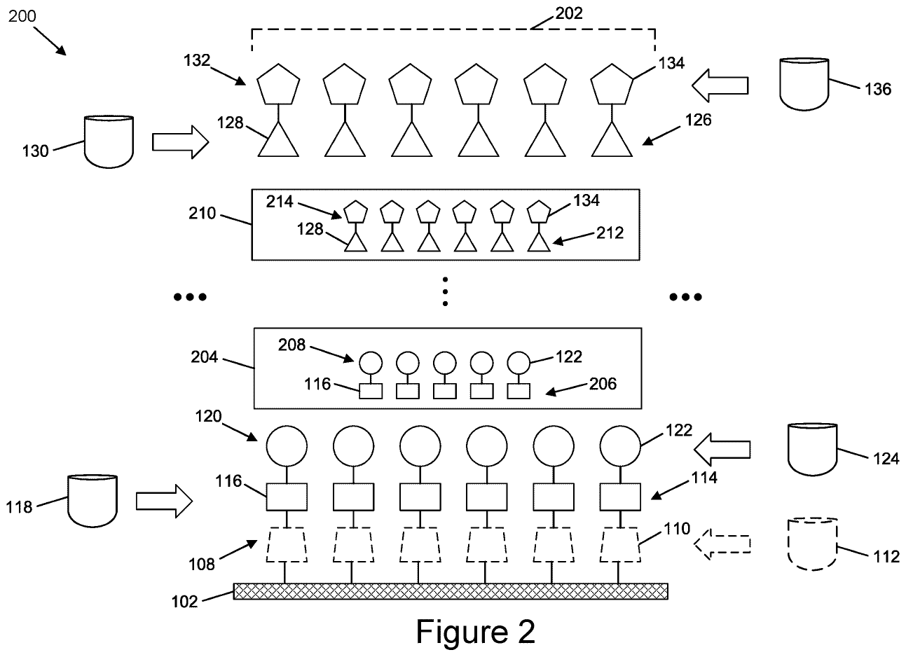

FIG. 2 illustrates an additional framework 200 to produce a coating 202 on a battery electrode material that includes a number of repeating sets of individual layers having one or more organic compounds, in accordance with one or more examples. Optionally, the coating 202 can include the intermediate layer 108 that is comprised of one or more intermediate organic compounds 110 and is formed by depositing an amount of an intermediate layer solution 112 on the substrate 102. In one or more examples, the coating 202 can include the first organic compound layer 108 that includes one or more first organic compounds 110 and that is formed from an amount of the first organic compound layer solution 118. The coating 202 can also include the second organic compound layer 120 that includes one or more second organic compounds 122 and that is formed from an amount of the second organic layer solution 124. In addition, the coating 202 can include the third organic compound layer 126 that includes one or more third organic compounds 128 and that is formed from an amount of the third organic layer solution 130. Further, the coating 202 can include the fourth organic compound layer 132 that includes one or more fourth organic compounds 134 and that is formed from an amount of the fourth organic layer solution 136.

In one or more examples, the coating 202 can include one or more first sets 204 that comprise an additional first organic compound layer 206 that includes the one or more first organic compounds 116. The one or more first sets 204 can also comprise an additional second organic compound layer 208 that includes the one or more second organic compounds 122. Additionally, the coating 202 can include one or more second sets 210 that comprise an additional third organic compound layer 212 that comprises the one or more third organic compounds 128. Further, the one or more second sets 210 can include an additional fourth organic compound layer 214 that includes the one or more fourth organic compounds 134. In various examples, the coating 202 can include multiple instances of the first set 204 and multiple instances of the second set 210.

In at least some examples, the first organic compound layer 114, the second organic compound layer 120, and a number of the first set 204 can be used to form a first polymeric compound where the individual monomer units of the first polymeric compound include the first organic compound 116 and the second organic compound 122. In one or more additional examples, the third organic compound layer 126, the fourth organic compound layer 132, and a number of the second set 210 can be used to form a second polymeric compound, where the individual monomer units of the second polymeric compound include the third organic compound 128 and the fourth organic compound 134.

In various examples, the one or more first organic compounds 116 can be different from the one or more second organic compounds 122. In these instances, the first polymeric molecule can include alternating monomeric units including a first organic compound 116 and a second organic compound 122. Additionally, the one or more third organic compounds 128 can be different from the one or more fourth organic compounds 134. In these scenarios, the second polymeric molecule can include alternating monomeric units including a third organic compound 128 and a fourth organic compound 134. In one or more additional examples, the one or more first organic compounds 116 can be the same as the one or more second organic compounds 122 and the one or more third organic compounds 128 can the same as the one or more fourth organic compounds 134. In these instances, the first polymeric molecule can include monomeric units that comprise a given molecule and the second polymeric molecule can include monomeric units that comprise an additional molecule different from the given molecule of the first polymeric molecule. In at least some examples, the one or more first organic compounds 116, the one or more second organic compounds 122, the one or more third organic compounds 128, and the one or more fourth organic compounds 134 can include a same molecule. In these implementations, the first organic compound layer 114, the second organic compound layer 120, the one or more first sets 204, the one or more second sets 210, the third organic compound layer 126, and the fourth organic compound layer 132 can form a number of instances of a polymeric molecule having a single monomeric unit.

In one or more illustrative examples, at least one of the first organic compound 116, the second organic compound 122, the third organic compound 128, or the fourth organic compound 134 can include at least one of one or more glucose molecules or one or more glucose-derived molecules.

In one or more additional illustrative examples, at least one of the first organic compound 116, the second organic compound 122, the third organic compound 128, or the fourth organic compound 134 can include an alkyl chain having from 2 to 8 carbon atoms and that includes an initial carbon atom and a terminal carbon atom. In at least some examples, the initial carbon atom and the terminal carbon atom can be individually substituted with at least one of an amine group, a hydroxyl group, a thiol group, a carboxylate group, a sulfonate group, or a phosphate group. In various examples, the initial carbon atom and the terminal carbon atom can be individually substituted with at least one of a carbodiimide group, an isothiocyanate group, an isocyanate group, an acyl halide group, an ester group, anhydride group, chloroformate ester, an ammonium group, or a phosphonium group. The alkyl chain can include zero or more intermediate carbon atoms between the initial carbon atom and the terminal carbon atom. In one or more scenarios, the intermediate carbon atoms can be unsubstituted.

In one or more further illustrative examples, at least one of the first organic compound 116, the second organic compound 122, the third organic compound 128, or the fourth organic compound 134 can include a monocyclic aromatic hydrocarbon having an aromatic ring comprising from 4 to 8 carbon atoms. In at least some examples, one or more carbon atoms of the aromatic ring can be substituted with at least one of an amine group, a hydroxyl group, a thiol group, a carboxylate group, a sulfonate group, or a phosphate group. Additionally, one or more carbon atoms of the aromatic ring can be substituted with at least one of a carbodiimide group, an isothiocyanate group, an isocyanate group, an acyl halide group, an ester group, anhydride group, a chloroformate ester group, an ammonium group, or a phosphonium group.

In still other illustrative examples, at least one of the first organic compound 116, the second organic compound 122, the third organic compound 128, or the fourth organic compound 134 can include an alkyl chain having from 2 to 8 carbon atoms. The alkyl chain can have an initial carbon atom, a terminal carbon atom, and, optionally, one or more intermediate carbon atoms. In one or more examples, at least one of the initial carbon atom, the terminal carbon atom, or the one or more intermediate carbon atoms can be substituted with at least one halogen. In at least some examples, the at least one halogen can be fluorine. In one or more additional examples, the initial carbon atom and the terminal carbon atom can be individually substituted with at least one of an amine group, a hydroxyl group, thiol, carboxylate, sulfonate, or a phosphate group. In one or more further examples, the initial carbon atom and the terminal carbon atom can be individually substituted with at least one of a carbodiimide group, an isothiocyanate group, an isocyanate group, an acyl halide group, an ester group, anhydride group, chloroformate ester, ammonium, or a phosphonium group.

In various illustrative examples, at least one of the first organic compound 116, the second organic compound 122, the third organic compound 128, or the fourth organic compound 134 can include at least two ether groups with a first ether group of the at least two ether groups including an initial carbon atom and a second ether group of the at least two ether groups including a terminal carbon atom. In one or more examples, the at least two ether groups can be linearly arranged and the at least two ether groups can individually include from 2 to 8 carbon atoms. In addition, the initial carbon atom and the terminal carbon atom can be individually substituted with at least one of an amine group, a hydroxyl group, a thiol group, a carboxylate group, a sulfonate group, or a phosphate group. Further, the initial carbon atom and the terminal carbon atom can be individually substituted with at least one of a carbodiimide group, an isothiocyanate group, an isocyanate group, an acyl halide group, an ester group, anhydride group, a chloroformate ester group, an ammonium group, or a phosphonium group.

Although the illustrative of example of FIG. 2 shows two repeating sets that each include two organic compounds, in additional examples, the coating 202 can include more or fewer repeating sets with the repeating sets including more or fewer organic compounds.

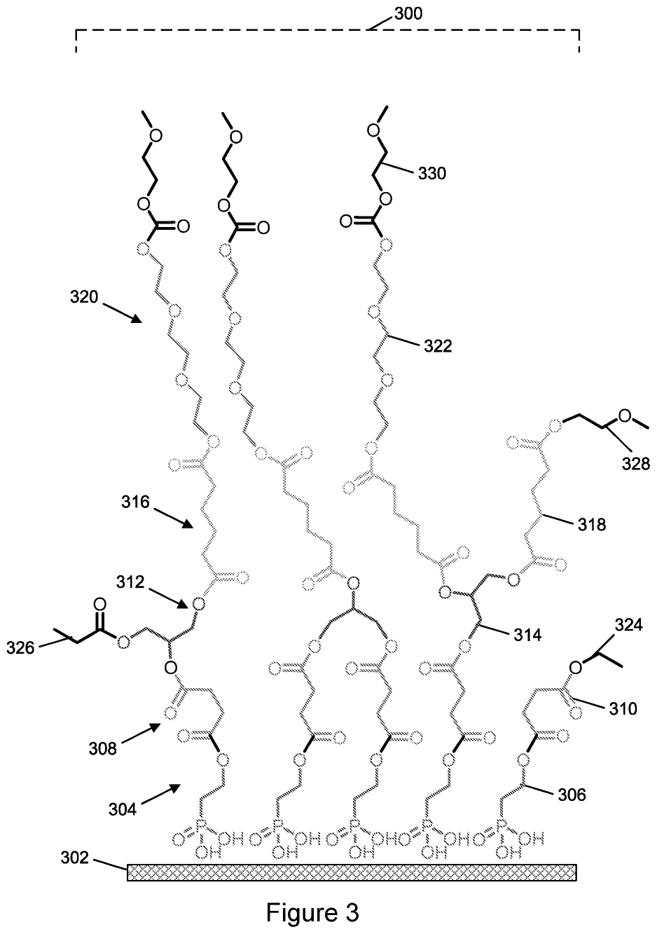

FIG. 3 illustrates a coating 300 that overlays a substrate 302 of battery electrode material, where the coating 300 includes a number of individual layers formed from individual organic compounds, in accordance with one or more examples. The coating 300 can include an anchoring layer 304 comprised of an anchoring molecule 306. In the illustrative example of FIG. 3, the anchoring molecule 306 can be formed from a derivative of phosphoric acid, such as 2-hydroxyethyl dihydrogen phosphate.

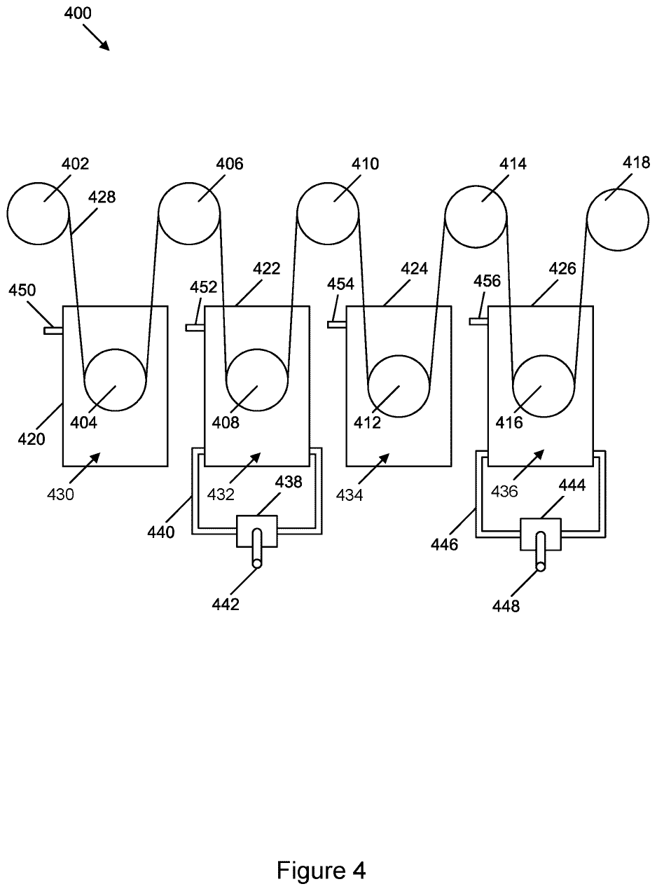

The coating 300 can also include a number of organic compound layers. For example, the coating 300 can include a first organic compound layer 308 comprised of a first organic compound 310. In the illustrative example of FIG. 3, the first organic compound 310 can be formed from a derivative of succinic acid, such as succinyl chloride. The coating 300 can also include a second organic compound layer 312 comprised of a second organic compound 314. In the illustrative example of FIG. 3, the second organic compound 314 can be formed from glycerol. Additionally, the coating 300 can include a third organic compound layer 316 comprised of a third organic compound 318. In the illustrative example of FIG. 3, the third organic compound 318 can be formed from a derivative of adipic acid, such as adipoyl chloride. Further, the coating 300 can include a fourth organic compound layer 320 comprised of a fourth organic compound 322. In the illustrative example of FIG. 4, the fourth organic compound 322 can be derived from triethylene glycol. In one or more illustrative examples, the anchoring molecule 306, the first organic compound 310, the second organic compound 314, the third organic compound 318, and the fourth organic compound 322 can comprise a chain of molecules extending away from the substrate 302.

The coating 300 can also include a number of capping compounds. In at least some examples, solutions comprising different capping compounds or different capping compound precursors can be applied to the individual layers of the coating 300. For example, a first capping solution can be applied to the first organic compound layer 308 to cause a first capping compound 324 to bond with one or more unreacted functional groups of molecules of the first organic compound 310 included in the first organic compound layer 308. In the illustrative example of FIG. 3, the first capping compound 324 can be derived from ethanol. A second capping solution can be applied to the second organic compound layer 312 to cause a second capping compound 326 to bond with one or more unreacted functional groups of molecules of the second organic compound 314 included in the second organic compound layer 312. In the illustrative example of FIG. 3, the second capping compound 326 can be derived from propionyl chloride.

Additionally, a third capping solution can be applied to the third organic compound layer 316 to cause a third capping compound 328 to bond with one or more unreacted functional groups of molecules of the third organic compound 318 included in the third organic compound layer 316. In the illustrative example of FIG. 3, the third capping compound 328 can be derived from methoxypropane. Further, a fourth capping solution can be applied to the fourth organic compound layer 320 to cause a fourth capping compound 330 to bond with one or more unreacted functional groups of molecules of the fourth organic compound 322 included in the fourth organic compound layer 320. In the illustrative example of FIG. 3, the fourth capping compound 330 can be derived from 2-methoxyethyl chloroformate.

FIG. 4 illustrates a system 400 to deposit a number of layers of a coating including one or more organic compounds on a battery electrode material, in accordance with one or more examples. In one or more examples, the system 400 can be used to deposit coatings on battery electrode materials, such as the coatings 106 described with respect to FIG. 1, the coatings 202 described with respect to FIG. 2, and the coating 300 described with respect to FIG. 3. The system 400 can include a number of chambers and a conveying apparatus that uses rollers to guide or direct a substrate of battery electrode material through the number of chambers in a sequential manner.

The system 400 can include a number of rollers, such as a first roller 402, a second roller 404, a third roller 406, a fourth roller 408, a fifth roller 410, a sixth roller 412, a seventh roller 414, an eighth roller 416, and a ninth roller 418. In one or more examples, the rollers 402, 404, 406, 408, 410, 412, 414, 416, 418 can include tensioning rollers. In various examples, the rollers 402, 404, 406, 408, 410, 412, 414, 416, 418 can be driven by one or more conveying motors (not shown in FIG. 4). The system 400 can also include a first chamber 420, a second chamber 422, a third chamber 424, and a fourth chamber 426. The rollers 402, 404, 406, 408, 410, 412, 414, 416, 418 can operate to guide or direct a substate 428 through the reaction chambers 420, 422, 424, 426. In this way, the system 400 can provide a continuous liquid deposition process for producing a coating comprising one or more organic compounds onto the surface of the substrate 428.

The first chamber 420 can include a first liquid solution 430, the second chamber 422 can include a second liquid solution 432, the third chamber 424 can include a third liquid solution 434, and the fourth chamber 426 can include a fourth liquid solution 436. At least a portion of the chambers 420, 422, 424, 426 can be configured as reaction chambers to hold reaction liquids that cause one or more layers of a coating to be formed on the substrate 428. In various examples, the reaction liquids can include organic compound solutions that include one or more organic compounds and/or one or more organic compound precursors that participate in reactions to form one or more layers of a coating on the substrate 428. The one or more organic compound solutions can also include one or more solvents. Additionally, at least a portion of the chambers 420, 422, 424, 426 can be configured as rinsing chambers to rinse reaction liquids off the substrate 428. Further, at least a portion of the chambers 420, 422, 424, 426 can be configured to apply one or more solutions comprising one or more capping compounds and/or one or more capping compound precursors to the substrate 428. In one or more illustrative examples, the first chamber 420 and the third chamber 424 can be configured as reaction vessels and the second chamber 422 and the fourth chamber 426 can be configured as rinsing vessels. In one or more additional illustrative examples, the first chamber 420 can be configured to apply an organic compound layer solution to the substrate 428 to form an organic compound layer on the substrate 428 and the third chamber 424 can be configured to apply a capping compound solution to the substrate 428 to attach one or more capping compounds to the organic compound layer. In one or more further illustrative examples, the first chamber 420 can be configured to apply a first organic compound layer solution to the substrate 428 to form a first organic compound layer on the substrate 428 and the third chamber 424 can be configured to apply a second organic compound layer solution to the substrate 428 to form a second organic compound layer on the first organic compound layer.

Although the illustrative example of FIG. 4 includes 9 rollers and 4 chambers, in other implementations, the system 400 can include more rollers or fewer rollers and/or more chambers or fewer chambers. In various examples, the number of rollers increases as the number of chambers increases and the number of rollers decreases as the number of chambers decreases. The number of chambers included in the system 400 can be based on at least one of a number of organic compound layers to be deposited on the substrate 428, a number of capping compounds to be added to the organic compound layers, or a number of rinsing operations to be performed.

In implementations where the second chamber 422 is a rinse chamber, the second chamber 422 can be connected to a first filtration apparatus 438. The first filtration apparatus 438 can include a first residue tube 440 that is connected to the second chamber 422 and a first permeate collection tube 442. Additionally, in implementations where the fourth chamber 426 is a rinse chamber, the fourth chamber 426 can be connected to a second filtration apparatus 444. The second filtration apparatus 444 can include a second residue tube 446 that is connected to the fourth chamber 426 and a second permeate collection tube 448.

Additionally, in implementations where the first chamber 420 and the third chamber 424 are reaction chambers, the first chamber 420 and the third chamber 424 can include a sensor for determining or measuring the volume of first liquid solution 430 and the volume of the third liquid solution 434 contained in the respective chambers 420, 424 and/or the concentration of one or more organic compounds in the first liquid solution 430 and the third liquid solution 434. The sensor can include an ion-selective electrode. In one or more additional implementations where the first chamber 420 and the third chamber 424 are reaction chambers, the first chamber 420 and the third chamber 424 can include a regulating valve that is electronically actuated by the sensor.

When a sensor (such as a float switch) in the first chamber 420 determines that a volume of the first liquid solution 430 is less than a threshold volume, a valve can open to enable an additional amount of the first liquid solution 430 to flow into the first chamber 420. Additionally, in response to a sensor in the third chamber 420 determining that a volume of the third liquid solution 434 is less than a threshold volume, a valve can open to enable an additional amount of the third liquid solution 434 to flow into the third chamber 424. In at least some examples, a pump (such as a peristaltic pump) can be used to drive at least one of the first liquid solution 430 into the first chamber 420 or the third liquid solution 434 into the third chamber 424. When the respective sensor determines that the first liquid solution 430 or the third liquid solution 434 is at the desired level, the valve closes, preventing excess liquid solution from flowing into the first chamber 420 or the third chamber 424.

In some cases, if the respective sensor determines that the first liquid solution 430 or the second liquid solution 432 is too high in the first chamber 420 or the third chamber 424, the valve opens up, allowing the excess liquid to flow out of the first chamber 420 or the third chamber 424. In the case that the sensor detects concentration of one or more organic compounds, a valve of the first chamber 420 or a valve of the third chamber 424 can expose the first chamber 420 or the third chamber 424 to a stock solution of relatively higher concentration of the one or more organic compounds in the circumstance that the concentration of the one or more organic compounds in the first chamber 420 or the third chamber 424 is detected to be less than a threshold level. Further, in situations where a sensor of the first chamber 420 or a sensor of the third chamber 424 detects that a concentration of one or more organic compounds in the first chamber 420 or the third chamber 424 is greater than a specified level, a valve can be actuated to add an amount of solvent to dilute the concentration of the one or more organic compounds until the concentration of the one or more organic compounds reaches a desired level.

In various examples where the second chamber 422 and the fourth chamber 426 are rinsing chambers, the second liquid solution 432 and/or the fourth liquid solution 436 can comprise one or more solvents for rinsing the substrate 428 after being contacted by the first solution 430 and the third solution 434, respectively. Rinsing the substrate 428 in the second chamber 422 can produce a first residual solution that comprises the one or more solvents of the rinsing solution and an amount of one or more first organic compounds included in the first liquid solution 430. Additionally, rinsing the substrate 428 in the fourth chamber 426 can produce a second residual solution that comprises the one or more solvents of the rinsing solution and an amount of one or more second organic compounds included in the second liquid solution 432.

The system 400 can further comprise a first valve 450 located on the first chamber 420, a second valve 452 located on the second chamber 422, a third valve 454 located on the third chamber 424, and a fourth valve 456 located on the fourth chamber 426. The first valve 450 can be connected to a source of the first liquid solution 430 to supply an additional amount of the first liquid solution 430 to the first chamber 420. In addition, the second valve 452 can be connected to a source of the second liquid solution 432 to supply an additional amount of the second liquid solution 432 to the second chamber 422. Further, the third valve 454 can be connected to a source of the third liquid solution 434 to supply an additional amount of the third liquid solution 434 to the third chamber 424. In various examples, the fourth valve 456 can be connected to a source of the fourth liquid solution 436 to supply an additional amount of the fourth liquid solution 436 to the fourth chamber 426. The valves 450, 452, 454, 456 may be electrically actuated and opened by the triggering of a sensor (not shown), which is adapted to monitor or measure the volume or concentration of liquid solution in a chamber 420, 422, 424, or 426. The sensors may be dipped into the liquid solution of each chamber 420, 422, 424, or 426.

In one or more illustrative examples, a first portion of the substrate 428 can be placed on a first roller 402. The first portion of the substrate 428 can be attached to the first roller 402, such as by glue or tape, to a leader material that is strung through the rest of rollers 404, 406, 408, 410, 412, 414, 416, 418. In this way, the leader material can guide the substrate 428 through the conveying apparatus as different solutions are applied to the substrate 428. The leader material can then be removed from the substrate once the portion of the substrate 428 that was placed on the first roller 402 is conveyed to the ninth roller 418 or when a coating has been fully formed on the substrate 428. An example of such a leader material may be from a previous roll of substrate. To illustrate, in advance of the coating of a specific substrate, the previous roll of substrate may have had a relatively long trailing length and may not include any electrode material. Once the previous roll has been processed, this remnant is left strung on the conveying apparatus, and any remaining active material on the substrate can be slit and removed. The remnant will then act as a leader to guide the next roll of substrate through the conveying apparatus.

After placing a first portion of the substrate 428 on the first roller 402, the first portion of the substrate 428 is conveyed into first chamber 420 by movement of second roller 404, which is also located within first chamber 420. The first portion of the substrate 428 is exposed within the first chamber 420 to a first liquid solution 430 to produce a first layer comprising one or more organic compounds on the surface of the first portion of the substrate 428. The first portion of substrate 428 is left in first chamber 420 for a certain residence time in order for one or more reactions to take place to form a layer of a coating on the first portion of the substrate 428. Once the reaction is substantially completed, the first portion of substrate 428 is withdrawn from the first chamber 420 by moving the first portion of the substrate 428 upward to the third roller 406. As the first portion of the substrate 428 is moved out of the first chamber 420, a second portion of the substrate 428 is conveyed into the first chamber 420. In this way, the system 400 operates in a continuous manner until at least one layer of a coating is formed on a desired amount of the substrate 428.

Returning back to the first portion of the substrate 428, the first portion of the substrate 428 is then conveyed to the second chamber 422 by movement of the fourth roller 408, which is located within the second chamber 422. The second chamber 422 can include the second liquid solution 432. The second liquid solution 432 can include one or more capping compounds or one or more capping compound precursors, one or more additional organic coating layer compounds or one or more additional organic coating layer compound precursors, or a rinsing solution. In scenarios where the second liquid solution 432 includes a rinsing solution, the first filtration apparatus 438 can separate unreacted organic coating layer compounds from the first liquid solution 430. The filtration apparatus can be any device that can perform such a separation. In one or more examples, the filtration apparatus 438 can include at least one of a membrane, a filtration column, a chromatographic column, a chemical or electrochemical separation tank, or an adsorption column. In various examples, the first filtration apparatus 438 can produce a permeate stream enriched in one or more unreacted organic coating layer compounds from the first liquid solution 430 and depleted in one or more solvents included in the first liquid solution 430 and a residue stream enriched in the one or more solvents of the first liquid solution 430 and depleted in one or more unreacted organic compounds of the first liquid solution 430 as compared to the permeate stream. The permeate stream can be collected in the first permeate collection tube 442, which may be recycled or sent back to the first chamber 420. The residue stream can be recycled back to the second chamber, 422 via first residue tubing 440. The first filtration apparatus 438 can operate periodically or continuously. From the second chamber 422, the first portion of the substrate 428 is then withdrawn from the second chamber 422 by moving the first portion of the substrate 428 upward to the fifth roller 410.

The first portion of the substrate 428 can then be conveyed into the third chamber 424, by moving downward to the sixth roller 412, which is also located within the third chamber 424. The third chamber 424 can include the third liquid solution 434. In one or more examples, the third liquid solution 434 can include one or more capping compounds or one or more capping compound precursors to undergo one or more reactions to add the one or more capping compounds to unreacted functional groups of a layer of a coating of the substrate 428. In one or more additional examples, the third liquid solution 434 can include one or more organic coating layer compounds or one or more organic coating layer compound precursors that can undergo one or more reactions to add an additional layer to a coating of the substrate 428. In one or more further examples, the third liquid solution 434 can include a rinsing solution. After the one or more reactions are substantially completed, the first portion of substrate 428 can then be withdrawn from the third chamber 424 by moving upward to the seventh roller 414.

The first portion of the substrate 428 can then be conveyed to the fourth chamber 426 by moving downward to the eighth roller 416, which is also located within fourth chamber 426. The fourth chamber 426 can include one or more capping compounds or one or more capping compound precursors, one or more additional organic coating layer compounds or one or more additional organic coating layer compound precursors, or a rinsing solution. In scenarios where the fourth liquid solution 436 includes a rinsing solution, the rinsing solution can include one or more solvents for rinsing the substrate 428. In at least some examples, the one or more solvents included in the fourth liquid solution 436 can be different from one or more solvents included in a previous rinsing solution, such as the second liquid solution 432 or the third liquid solution 434. In at least some examples, the fourth liquid solution 436 can also include a residual solution comprising an amount of one or more solvents included in fourth liquid solution 436 or an amount of one or more unreacted organic compounds.

In situations where the fourth liquid solution 436 includes a rinsing solution, the rinsing solution can be sent to the second filtration apparatus 444. The second filtration apparatus 444 can produce a permeate stream enriched in one or more unreacted organic coating layer compounds and/or one or more unreacted capping compounds and depleted in one or more solvents of the rinsing solution. The second filtration apparatus 444 can also produce a residue stream enriched in one or more solvents of the rinsing solution and depleted in one or more unreacted organic coating layer compounds or precursors and/or one or more unreacted capping compounds or precursors in relation to the fourth liquid solution 436. The permeate stream can be collected in the second permeate collection tube 448 which may be recycled or sent back to the third chamber 424 or the second chamber 422. The residue stream can be recycled back to the fourth chamber 426 via the second residue tubing 446. The second filtration apparatus 444 can be operated periodically or continuously. The first portion of the substrate 428 can then be withdrawn from the fourth chamber 426 by being conveyed up to the ninth roller 418 while other portions of the substrate 428 move through the system 400 via the other rollers 402, 404, 406, 408, 410, 412, 414, 416.

Although the illustrative example of FIG. 4 shows that layers of a coating can be deposited on the substrate 428 using one or more of the chambers 420, 422, 424, 426, in other examples, at least a portion of the chambers 420, 422, 424, 426 can be replaced with slot-die or gravure coating reaction chambers (not shown). In these situations, one or more rinse chambers may or may not be present, depending on the need for a rinse step. In still other examples, rather than implementing one or more rinse steps, other excess solution removal techniques can be used, such as an air knife, doctor blade, metering knife, one or more combinations thereof, and the like. In various additional examples, more or fewer chambers can be present in the system 400. As such, the system 400, both in terms of deposition equipment and conveying equipment, can be considered to be modular and assembled in any specific manner so as to facilitate a specific solution-deposition process.

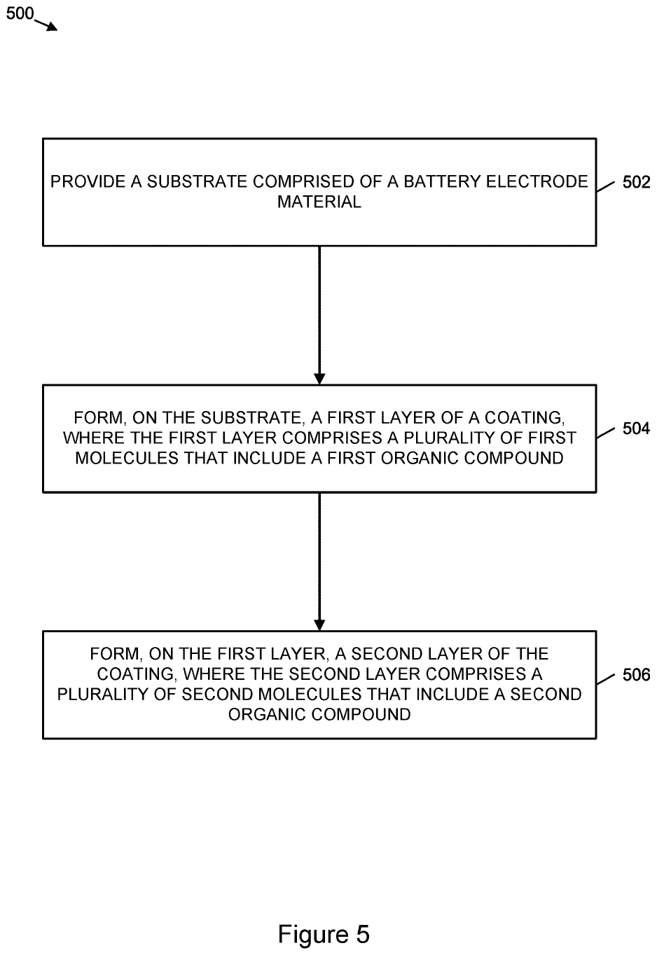

FIG. 5 illustrates a flow diagram of a process 500 to deposit a number of layers of a film including an organic compound on a battery electrode material, in accordance with one or more examples. At 502, the process 500 can include providing a substrate comprised of a battery electrode material. The battery electrode material can include one or more compounds of battery anodes. In addition, the battery electrode material can include one or more compounds of battery cathodes. In one or more illustrative examples, the battery electrode material can include C, Si, Sn, Ge, Al, P, Zn, Ga, As, Cd, In, Sb, Pb, Bi, SiO, SnO₂, Si, Sn, lithium metal, LiNiₓMn_{y}CozO₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur, or LiCoO₂ where x, y and z are stoichiometric coefficients.

In addition, at 504, the process 500 can include forming, on the substrate, a first layer of a coating for the battery electrode material. The first layer can comprise a plurality of molecules that include a first organic compound. Further, the process 500 can include, at operation 506, forming, on the first layer, a second layer of the coating on the first layer. The second layer can comprise a plurality of second molecules that include a second organic compound to form at least a portion of a coating on the substrate. In one or more examples, at least one of the first layer of the coating or the second layer of the coating can be formed using one or more solution deposition techniques. For example, at least one of the first layer or the second layer can be formed by at least one of submerging, spraying, slot die coating, bath coating, or gravure roller coating.

In one or more illustrative examples, the first layer can be formed by contacting the substrate with a first solution comprising a first solvent and a first precursor that corresponds to the first molecules. In at least some examples, the first layer can be formed by contacting the substrate with the first solution at temperatures no greater than 100° C., no greater than 90° C., no greater than 80° C., no greater than 70° C., no greater than 60° C., no greater than 50° C., no greater than 40° C., or no greater than 30° C. In various examples, the first layer can be formed by contacting the substrate with the first solution at temperatures from about 20° C. to about 100° C., at temperatures from about 30° C. to about 80° C., or at temperatures from about 40° C. to about 60° C. In addition, the substrate can be contacted with the first solution for no greater than 10 minutes, no greater than 8 minutes, no greater than 6 minutes, no greater than 5 minutes, no greater than 4 minutes, no greater than 3 minutes, no greater than 2 minutes, no greater than 1 minute, no greater than 45 seconds, no greater than 30 seconds, or no greater than 15 seconds. In one or more additional illustrative examples, the substrate can be contacted with the first solution for a residence time from about 10 seconds to about 10 minutes, from about 20 seconds to about 1 minutes, from about 30 seconds to about 2 minutes, from about 1 minute to about 5 minutes, from about 2 minutes to about 8 minutes, or from about 3 minutes to about 6 minutes.

Additionally, the second layer can be formed by contacting the first molecules of the first layer with a second solution comprising a second solvent and a second precursor that corresponds to the second molecules. In at least some examples, the second layer can be formed by contacting the substrate with the second solution at temperatures no greater than 100° C., no greater than 90° C., no greater than 80° C., no greater than 70° C., no greater than 60° C., no greater than 50° C., no greater than 40° C., or no greater than 30° C. In various examples, the second layer can be formed by contacting the substrate with the second solution at temperatures from about 20° C. to about 100° C., at temperatures from about 30° C. to about 80° C., or at temperatures from about 40° C. to about 60° C. In addition, the substrate can be contacted with the second solution for no greater than 10 minutes, no greater than 8 minutes, no greater than 6 minutes, no greater than 5 minutes, no greater than 4 minutes, no greater than 3 minutes, no greater than 2 minutes, no greater than 1 minute, no greater than 45 seconds, no greater than 30 seconds, or no greater than 15 seconds. In one or more additional illustrative examples, the substrate can be contacted with the second solution for a residence time from about 10 seconds to about 10 minutes, from about 20 seconds to about 1 minutes, from about 30 seconds to about 2 minutes, from about 1 minute to about 5 minutes, from about 2 minutes to about 8 minutes, or from about 3 minutes to about 6 minutes.

In various examples, the solvent included in the first solution and the second solution can include toluene, xylene, tetrahydrofuran, 1,4-dioxane, 1,2-dimethoxyethane, dichloromethane, chloroform, ethyl acetate, acetonitrile, N, N-dimethylformamide, dimethyl sulfoxide, water, or one or more combinations thereof. In one or more examples, the substrate can be placed into a first reaction container that includes the first solution to form an intermediate apparatus that includes the substrate with the first layer formed on the at least a portion of substrate. The intermediate apparatus can then be placed into a second reaction container that includes the second solution to produce an additional intermediate apparatus that includes the substrate, the first layer formed on the at least a portion of the substrate, and the second layer formed on the at least a portion of the first layer.

In one or more examples, the coating can be formed by performing one or more cycles of adding one or more layers onto the substrate. In at least some examples, a first cycle can include forming an instance of the first layer followed by forming an instance of the second layer on the first layer. In various examples, the first cycle can be repeated to form a number of layers having a pattern that alternates between a first layer including the first molecules and a second layer including the second molecules. In one or more additional examples, one or more third layers including a plurality of third molecules can be formed as part of the coating. Further, one or more fourth layers including a plurality of third molecules can be formed as part of the coating. The formation of a third layer and a fourth layer can comprise a second cycle of forming layers of the coating. In one or more illustrative examples, a number of instances of the first cycle can be repeated followed by a number of instances of the second cycle. In these scenarios, the coating can comprise a number of repeating instances of a first pattern including a first layer including a number of first molecules followed by a second layer including a number of second molecules followed by a number of repeating instances of a second pattern including a third layer including a number of third molecules followed by a fourth layer including a number of fourth molecules. In one or more additional illustrative examples, an instance of the first cycle can be followed by an instance of the second cycle and the process of performing an instance of the first cycle and an instance of the second cycle can be repeated a number of times. In these instances, a number of instances of a pattern including a first layer having a number of first molecules, a second layer having a number of second molecules, a third layer having a number of third molecules, and a fourth layer having a number of fourth molecules can be repeated.

In forming layers on top of one another during the formation of the coating, a layer that has previously been deposited and upon with a subsequent layer is formed can be referred to herein as a base layer. To illustrate, a first layer having one or more first organic compounds can be deposited and can be a base layer for a second layer that is deposited on the first layer and includes one or more second organic compounds or that includes the one or more first organic compounds. The second layer can then be an additional base layer for a third layer that is deposited on the second layer and includes one or more third organic compounds, the one or more second organic compounds, or the one or more first organic compounds.

The coating can have a thickness that is based on the number of layers included in the coating. In one or more examples, a single layer of the coating can have a thickness no greater than 100 nm, no greater than 90 nm, no greater than 80 nm, no greater than 70 nm, no greater than 60 nm, no greater than 60 nm, no greater than 50 nm, no greater than 40 nm, no greater than 30 nm, no greater than 20 nm, no greater than 10 nm, or no greater than 5 nm. In various examples, the coating can have a thickness from about 0.1 nanometers (nm) to about 5 nm, from about 0.2 nm to about 3 nm, from about 0.4 nm to about 1 nm, from about 0.2 nm to about 0.8 nm, from about 0.6 nm to about 2 nm, or from about 0. 4 nm to about 1.2 nm. In one or more illustrative examples, the coating can have a total thickness from about 0.5 nm to about 30 nm, from about 1 nm to about 20 nm, from about 2 nm to about 10 nm, from about 3 nm to about 15 nm, from about 4 nm to about 20 nm, from about 5 nm to about 25 nm, from about 10 nm to about 30 nm, from about 10 nm to about 100 nm, from about 20 nm to about 80 nm, or from about 10 nm to about 50 nm.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is an apparatus comprising: a battery electrode material, having a coating comprising an organic compound, where the coating has a thickness of no greater than 100 nm.

In Example 2, the subject matter of example 1, wherein the coating comprises a layer having a backbone moiety and at least two functional groups coupled to the backbone moiety, the backbone moiety comprising (i) an alkyl chain having no greater than 8 carbon atoms, (ii) a cyclic aromatic hydrocarbon group, (iii) a fluorinated alkyl chain having no greater than 8 carbon atoms, (iv) one or more ether groups, or (v) a polymeric compound having a molecular weight no greater than 1 million Daltons (Da) and comprised of monomer units that include no greater than 10 carbon atoms.

In Example 3, the subject matter of example 2, wherein a first functional group of the at least two functional groups includes a first electrophilic group or a first nucleophilic group and a second functional group of the at least two functional groups includes a second electrophilic group or a second nucleophilic group.

In Example 4, the subject matter of example 3, wherein the first electrophilic group or the second electrophilic group includes a carbodiimide group, an isothiocyanate group, an isocyanate group, an acyl halide group, an ester group, anhydride group, chloroformate ester, ammonium, or a phosphonium group.

In Example 5, the subject matter of example 3 or 4, wherein the first nucleophilic group or the second nucleophilic group includes an amine, an alcohol, or a thiol.

In Example 6, the subject matter of any one of examples 2-5, wherein the backbone moiety is coupled to a capping moiety.

In Example 7, the subject matter of example 6, wherein the capping moiety includes an electrophilic group or a nucleophilic group.

In Example 8, the subject matter of example 7, wherein the electrophilic group includes a carbodiimide group, an isothiocyanate group, an isocyanate group, an acyl halide group, an ester group, anhydride group, chloroformate ester, ammonium, or a phosphonium group.

In Example 9, the subject matter of example 7 or 8, wherein the nucleophilic group includes an amine, an alcohol, or a thiol.

In Example 10, the subject matter of any one of examples 1-9, wherein the coating comprises a plurality of layers.

In Example 11, the subject matter of example 10, wherein: a first layer of the plurality of layers includes a first backbone moiety and at least two first functional groups coupled to the first backbone moiety, the first backbone moiety comprising an alkyl chain having no greater than 8 carbon atoms, a monocyclic aromatic hydrocarbon group, a fluorinated alkyl chain having no greater than 8 carbon atoms, or one or more ether groups; and a second layer of the plurality of layers includes a second backbone moiety and at least two second functional groups coupled to the second backbone moiety, the second backbone moiety comprising an alkyl chain having no greater than 8 carbon atoms, a monocyclic aromatic hydrocarbon group, a fluorinated alkyl chain having no greater than 8 carbon atoms, or one or more ether groups.

In Example 12, the subject matter of example 11, wherein the first backbone moiety and the second backbone moiety are the same.

In Example 13, the subject matter of example 11, wherein the first backbone moiety is different from the second backbone moiety.

In Example 14, the subject matter of any one of examples 11-13, wherein the at least two first functional groups and the at least two second functional groups are the same.

In Example 15, the subject matter of any one of examples 11-13, wherein a first functional group of the at least two first functional groups is different from a second functional group of the at least two second functional groups.

In Example 16, the subject matter of any one of examples 11-15, wherein an intermediate layer is located between the substrate and the coating.

In Example 17, the subject matter of any one of examples 11-16, wherein the intermediate layer is comprised of one or more compounds that include a first additional functional group to attach to the substrate and a second additional functional group to attach to the coating.

In Example 18, the subject matter of any one of examples 1-17, wherein the intermediate layer includes an additional organic compound comprised of an alkyl chain having no greater than 8 carbon atoms attached to the first additional functional group and the second additional functional group.

In Example 19, the subject matter of example 18, wherein the first additional functional group includes a carboxylate group, a phosphate group, a halide group, halosilane, or a silicon alkoxide.

In Example 20, the subject matter of example 18 or 19, wherein the second additional functional group includes an alcohol, an amine, a thiol, an anhydride, or an isocyanate.

In Example 21, the subject matter of any one of examples 18-20, wherein the first additional functional group covalently bonds with one or more compounds of the substrate.

In Example 22, the subject matter of any one of examples 18-20, wherein the first additional functional group attaches non-covalently with one or more compounds of the substrate.

In Example 23, the subject matter of any one of examples 18-22, wherein the additional organic compound includes 3-hydroxypropanoic acid, 2-hydroxyethyl dihydrogen phosphate, hydroxymethyltriethoxysilane, b-alanine, 2-aminoethyl dihydrogen phosphate, (3-aminopropyl)triethoxysilane (APTES), 4-(triethoxysilyl)aniline, (3-triethoxysilyl)propylsuccinic anhydride, 3-isocyanatopropyltriethoxysilane, 3-mercaptopropanoic acid, 2-mercaptoethyl dihydrogen phosphate, or (3-mercaptopropyl)trimethoxysilane (MPTES).

In Example 24, the subject matter of any one of examples 1-23, wherein: the film comprises one or more layers with individual layers of the one or more layers including a number of instances of an organic compound; and one or more capping compounds are attached to at least a portion of the number of instances of the organic compound in an individual layer of the one or more layers.

In Example 25, the subject matter of example 24, wherein the one or more capping compounds include a hydroxyl group, an amine group, a thiol group, an acyl halide group, an ester group, an isocyanate group, an isothiocyanate group, a chloroformate group, an anhydride group.

In Example 26, the subject matter of example 24, wherein the one or more capping compounds include a nucleophilic functional group or an electrophilic functional group.

In Example 27, the subject matter of any one of examples 24-26, wherein the one or more capping compounds include benzylamine; propylamine; 2,2,2-trifluoroethyl amine; 2-methoxyethane-1-amine; phenol; benzyl alcohol; propanol; 2,2,2-trifluoroethanol; ethylene glycol monoethyl ether; benzoyl chloride; butyryl chloride; trifluoropropionyl chloride; 1-isocyanato-2-methoxyethane; furfuryl isocyanate; phenyl isocyanate; benzyl isocyanate; naphthyl isocyanate; cyclohexyl isocyanate; butyl isocyanate; 3,5-bis(trifluoromethyl)phenylisocyanate; 4-(trifluoromethyl)phenyl isocyanate; pentafluorophenyl isocyanate; mPEG-isocyanate; phenyl chloroformate; benzyl chloroformate; pentafluorobenzyl chloroformate; Fmoc-chloride; methyl chloroformate; butyl chloroformate; propyl chloroformate; pentyl chloroformate; 2,2,2-Trifluoroethyl chloroformate; 2-methoxyethyl chloroformate; vinyl chloroformate, allyl chloroformate; or propargyl chloroformate.

In Example 28, the subject matter of any one of examples 1-27, wherein the coating is comprised of a number of groups of molecules coupled to the substrate.

In Example 29, the subject matter of example 28, wherein individual groups of molecules of the number of groups of molecules include a chain that includes one or more molecules, the chain extending away from the substrate.

In Example 30, the subject matter of example 29, wherein the chain of an individual group of molecules is comprised of a plurality of instances of a single molecule.

In Example 31, the subject matter of example 29, wherein the chain of an individual group of molecules is comprised of a plurality of different molecules.

In Example 32, the subject matter of any one of examples 29-31, wherein one or more molecules of an individual group of molecules is attached to one or more capping groups.

In Example 33, the subject matter of example 29, wherein a first number of molecules included in a first chain of a plurality of chains of the coating is different from a second number of molecules included in a second chain of the plurality of chains of the coating.

In Example 34, the subject matter of example 29, wherein the coating includes a plurality of layers with a first layer of the plurality of layers including a first molecule in the individual chain of molecules coupled to the substrate and a second layer of the plurality of layers including a second molecule in the individual chains of molecules coupled to the first molecule.

In Example 35, the subject matter of any one of examples 29-34, wherein the chain that includes the one or more molecules has a molecular weight no greater than 1 million Daltons (Da).

In Example 36, the subject matter of any one of examples 1-35, wherein a terminal layer is formed on the coating.

In Example 37, the subject matter of example 36, wherein the terminal layer comprises a polymeric material.

In Example 38, the subject matter of example 37 wherein the terminal layer comprises polyethylene glycol.

In Example 39, the subject matter of any one of examples 1-38, where the battery electrode material comprises one or more of the following elements or compounds: C, Si, Sn, Ge, Al, P, Zn, Ga, As, Cd, In, Sb, Pb, Bi, SiO, SnO2, Si, Sn, lithium metal, LiNixMnyCozO2, LiNixCoy AlzO2, LiMnxNiyOz, LiMn02, LiFePO4, LiMnPO4, LiNiPO4, LiCoPO4, LiV2O5, sulfur, or LiCoO2 where x, y and z are stoichiometric coefficients.

In Example 40, the subject matter of any one of examples 1-39, where the thin coating comprises one or more of the following organic compounds: phenylene diamine, melamine, 4,4′-oxydianiline; 4,4′-(1,4-phenylenediisopropylidene)bisaniline; emeraldine, leucoemeraldine, polypyrrole, poly(4-vinylpyridine), poly(4-vinylaniline); ethylene diamine; propylene diamine; diethylenetriamine; triethylenetetraamine; tetraethylenepentamine; pentaethylene hexamine; polyethyleneimine; polyallylamine; 3,5-bis(trifluoromethyl)phenylene-1,2-diamine; 2-(2-aminoethoxy)ethylamine; 2,2′-(ethylenedioxy)bis(ethylamine); 1,11-diamino-3,6,9-trioxaundecane; polyethyleneglycol amine terminated; hydroquinone, xylene-α,α′-diol; bisphenol P; bisphenol A; poly(4-vinylphenol); ethane-1,2-diol; propane-1,3-diol; glycerol; polyvinyl alcohol; polyallyl alcohol; 2,2,3,3-tetrafluoro-1,4-butanediol; hexafluoro-2,3-bis(trifluoromethyl)-2,3-butanediol; 1H,1H,8H,8H-perfluoro-3,6-dioxaoctane-1,8-diol; diethylene glycol; dipropylene glycol triethylene glycol; polyethylene glycol; paraformaldehyde; polypropylene glycol; 1,3,4-thiadiazole-2,5-dithiol; benzene-1,4-dithiol; 1,4-benzenedimethanethiol; trithiocyanuric acid biphenyl-4,4′-dithiol; 1,2-ethanethiol; 1,6-hexanedithiol; 1,11-undecanedithiol; trimethylolpropane tris(3-mercaptopropionate); pentaerythritol tetrakis(3-mercaptopropionate); 2,2′-thiodiethanethiol; tetra(ethylene glycol) dithiol; poly(ethylene glycol) dithiol; terephthaloyl chloride, trimesoyl chloride; oxalyl chloride, succinyl chloride; polyacryloyl chloride; polymethacryloyl chloride; tetrafluorosuccinyl chloride; tetrafluoroterephthaloyl chloride; 2,2′-oxydiacetyl chloride; toluene 2,4-diisocyanate, 4,4′-diphenylmethanediisocyanate; poly[(phenyl isocyanate)-co-formaldehyde; hexamethylene diisocyanate; 4,4′-methylenebis(cyclohexyl isocyanate); poly(hexamethylene diisocyanate); 4arm-PEG-isocyanate; poly(propylene glycol)-tolylene 2,4-diisocyanate terminated; 1,4-phenylene bis(chloroformate); bisphenol A bis(chloroformate); ethylenebis(chloroformate); di(ethylene glycol) bis(chloroformate); tri(ethylene glycol) bis(chloroformate); 1,4-phenylene diisothiocyanate; tolylene-2,4-diisothiocyanate; 4,4′-diisothiocyanatodiphenylmethane; 4,4′-methylenebis(2-chlorophenyl)diisothiocyanate; butane-1,4-diisothiocyanate.

In Example 41, the subject matter of example 2, wherein the organic compound comprises a polymeric compound comprised of a plurality of monomer units with individual monomer units comprising the backbone moiety.

In Example 42, the subject matter of example 41, wherein the individual monomer units include one or more glucose molecules or one or more glucose-derived molecules.

In Example 43, the subject matter of example 41, wherein the individual monomer units include an alkyl chain having from 2 to 8 carbon atoms, the alkyl chain having an initial carbon atom and a terminal carbon atom.

In Example 44, the subject matter of example 43, wherein the initial carbon atom and the terminal carbon atom are individually substituted with at least one of an amine group, a hydroxyl group, thiol, carboxylate, sulfonate, or a phosphate group.

In Example 45, the subject matter of example 43, wherein the initial carbon atom and the terminal carbon atom are individually substituted with at least one of a carbodiimide group, an isothiocyanate group, an isocyanate group, an acyl halide group, an ester group, anhydride group, chloroformate ester, ammonium, or a phosphonium group.

In Example 46, the subject matter of example 41, wherein the alkyl chain includes zero or more intermediate carbon atoms between the initial carbon atom and the terminal carbon atom.

In Example 47, the subject matter of example 46, wherein the one or more intermediate carbon atoms are unsubstituted.

In Example 48, the subject matter of example 41, wherein the individual monomer units include a monocyclic aromatic hydrocarbon having an aromatic ring comprising from 4 to 8 carbon atoms.

In Example 49, the subject matter of example 48, wherein one or more carbon atoms of the aromatic ring are substituted with at least one of an amine group, a hydroxyl group, thiol, carboxylate, sulfonate, or a phosphate group.

In Example 50, the subject matter of example 49, wherein one or more carbon atoms of the aromatic ring are substituted with at least one of a carbodiimide group, an isothiocyanate group, an isocyanate group, an acyl halide group, an ester group, anhydride group, chloroformate ester, ammonium, or a phosphonium group.

In Example 51, the subject matter of example 41, wherein the individual monomer units include an alkyl chain having from 2 to 8 carbon atoms, the alkyl chain having an initial carbon atom, a terminal carbon atom, and, optionally, one or more intermediate carbon atoms, and wherein at least one of the initial carbon atom, the terminal carbon atom, or the one or more intermediate carbon atoms are substituted with at least one halogen.

In Example 52, the subject matter of example 51, wherein the at least one halogen is fluorine.

In Example 53, the subject matter of example 51, wherein the initial carbon atom and the terminal carbon atom are individually substituted with at least one of an amine group, a hydroxyl group, thiol, carboxylate, sulfonate, or a phosphate group.

In Example 54, the subject matter of example 51, wherein the initial carbon atom and the terminal carbon atom are individually substituted with at least one of a carbodiimide group, an isothiocyanate group, an isocyanate group, an acyl halide group, an ester group, anhydride group, chloroformate ester, ammonium, or a phosphonium group.

In Example 55, the subject matter of example 41, wherein the individual monomer units include at least two ether groups with a first ether group of the at least two ether groups including an initial carbon atom and a second ether group of the at least two ether groups including a terminal carbon atom.

In Example 56, the subject matter of example 55, wherein the at least two ether groups are linearly arranged and the at least two ether groups individually include from 2 to 8 carbon atoms.

In Example 57, the subject matter of example 55, wherein the initial carbon atom and the terminal carbon atom are individually substituted with at least one of an amine group, a hydroxyl group, thiol, carboxylate, sulfonate, or a phosphate group.

In Example 58, the subject matter of example 55, wherein the initial carbon atom and the terminal carbon atom are individually substituted with at least one of a carbodiimide group, an isothiocyanate group, an isocyanate group, an acyl halide group, an ester group, anhydride group, chloroformate ester, ammonium, or a phosphonium group.

In Example 59, the subject matter of example 55, wherein the individual monomer units comprise dihydroxyethane.

In Example 60, the subject matter of any one of examples 1-59, comprising a battery, and wherein the battery electrode material comprises an anode of the battery.

In Example 61, the subject matter of any one of examples 1-60, comprising a battery, and wherein the battery electrode material comprises a cathode of the battery.

In Example 62, an apparatus comprises: a substrate; and a film formed over the substrate, the film comprising an organic compound and the film having a thickness no greater than 100 nanometers (nm); wherein the organic compound includes a backbone moiety and at least two reactive functional groups, the backbone moiety comprising an alkyl chain having no greater than 8 carbon atoms, a benzyl group, an alkyl difluoride chain having no greater than 8 carbon atoms, or one or more ether groups individually having no greater than 8 carbon atoms.

In Example 63, a method comprises: providing a substrate comprised of a battery electrode material; forming a first layer comprising a plurality of first molecules on the substrate, individual first molecules of the first layer being attached to the substrate and individual first molecules of the first layer comprising a first organic compound; and forming a second layer comprising a plurality of second molecules on the first layer of molecules to form a film on the substrate, individual second molecules of the second layer being attached to one or more first molecules of the first layer, individual second molecules of the second layer comprising a second organic compound, and the film having a thickness no greater than 100 nanometers (nm).

In Example 64, the subject matter of example 63, wherein the first layer and the second layer are formed using one or more solution deposition techniques.

In Example 65, the subject matter of example 64, wherein at least one the first layer or the second layer is formed by at least one of submerging, spraying, slot die coating, bath coating, or gravure roller coating.

In Example 66, the subject matter of example 64, wherein: the first layer is formed by contacting the substrate with a first solution comprising a first solvent and a first precursor that corresponds to the first molecules; and the second layer is formed by contacting the first molecules of the first layer with a second solution comprising a second solvent and a second precursor that corresponds to the second molecules.

In Example 67, the subject matter of example 66, wherein the first solvent and the second solvent comprise toluene, xylene, tetrahydrofuran, 1,4-dioxane, 1,2-dimethoxyethane, dichloromethane, chloroform, ethyl acetate, acetonitrile, N,N-dimethylformamide, dimethyl sulfoxide, or water.

In Example 68, the subject matter of example 66 or 67, comprising: attaching one or more first capping groups to at least a portion of the plurality of first molecules by contacting the at least a portion of the plurality of first molecules with a first additional solution, the first additional solution comprising a first additional solvent and one or more first additional precursors that correspond to the one or more first capping groups; and attaching one or more second capping groups to at least a portion of the plurality of second molecules by contacting the at least a portion of the plurality of second molecules of the second layer with a second additional solution, the second additional solution comprising a second additional solvent and one or more second additional precursors that correspond to the one or more second capping groups.

In Example 69, the subject matter of example 68, wherein the second additional solution is applied to the at least a portion of the plurality of second molecules of the second layer after the one or more first capping groups are attached to the at least portion of the plurality of first molecules.

In Example 70, the subject matter of example 66, comprising: placing the substrate into a first reaction container that includes the first solution to form an intermediate apparatus that includes the substrate with the first layer formed over the at least a portion of substrate; and placing the intermediate apparatus into a second reaction container that includes the second solution to form an additional intermediate apparatus that includes the substrate, the first layer being formed over the at least a portion of the substrate, and the second layer being formed over the at least a portion of the first layer.

In Example 71, the subject matter of example 70, comprising: providing the substrate to the first reaction container using a conveyance apparatus; and providing the intermediate apparatus to the second reaction container using the conveyance apparatus.

In Example 72, the subject matter of any one of examples 63-71, comprising: forming an intermediate layer on the substrate such that the first layer of first molecules is formed over the intermediate layer, the intermediate layer including an additional organic compound comprised of an alkyl chain having no greater than 8 carbon atoms, a first additional functional group, and a second additional functional group.

In Example 73, the subject matter of example 72, wherein the first additional functional group includes a carboxylate group, a phosphate group, a halide group, halosilane group, or a silicon alkoxide.

In Example 74, the subject matter of example 72 or 73, wherein the second additional functional group includes an alcohol, an amine, a thiol, an anhydride, or an isocyanate.

In Example 75, the subject matter of any one of examples 72-74, wherein the first additional functional group covalently bonds with one or more compounds of the substrate.

In Example 76, the subject matter of any one of examples 72-74, wherein the first additional functional group attaches non-covalently with one or more compounds of the substrate.

In Example 77, the subject matter of any one of examples 72-76, wherein the intermediate layer is formed by contacting the substrate with an additional solution comprising an additional solvent and an additional precursor that corresponds to the additional organic compound.

In Example 78, the subject matter of any one of examples 72-77, wherein the first layer has a thickness from about 0.1 nm to about 10 nm and the second layer has a thickness from about 10 nm to about 30 nm.

In Example 79, the subject matter of any one of examples 63-78, comprising: performing a cycle that adds a number of layers to the film, wherein the cycle includes: forming an additional first layer including an additional plurality of first molecules on a base layer, the additional plurality of first molecules being individually attached to one or more molecules of the base layer; and forming an additional second layer including an additional plurality of second molecules on the additional first layer, the additional plurality of second molecules being individually attached to one or more of the plurality of first molecules.

In Example 80, the subject matter of example 79, comprising: repeating the cycle one or more times to add a number of layers to the film such that the film comprises multiple additional first layers comprising a number of first molecules and multiple additional second layers comprising a number of second molecules.

In Example 81, the subject matter of example 79, wherein the base layer is the second layer.

In Example 82, the subject matter of example 80, wherein the film includes individual additional second layers being arranged between individual additional first layers.

In Example 83, the subject matter of example 79, comprising: forming a third layer comprising a plurality of third molecules on an additional base layer of molecules, individual third molecules of the third layer being attached to one or more additional molecules of the additional base layer and the plurality of third molecules comprising a third organic compound; and forming a fourth layer comprising a plurality of fourth molecules on the third layer, individual fourth molecules of the fourth layer being attached to one or more third molecules of the third layer and individual fourth molecules of the fourth layer comprising a fourth organic compound.

In Example 85, the subject matter of example 83, wherein that additional base layer is the second layer.

In Example 86, the subject matter of example 83, comprising: performing an additional cycle that adds a number of additional layers to the film, wherein the additional cycle includes: forming an additional third layer comprising an additional plurality of third molecules on a further base layer, the additional plurality of third molecules being individually attached to one or more further molecules of the further base layer; and forming an additional fourth layer comprising an additional plurality of fourth molecules on the additional third layer, the additional plurality of fourth molecules being individually attached to one or more third molecules of the additional third layer.

In Example 87, the subject matter of example 85, wherein the base layer is the fourth layer.

In Example 88, the subject matter of example 85, comprising: repeating the additional cycle one or more times to add an additional number of layers to the film such that the film comprises multiple layers of the third molecules and multiple layers of the fourth molecules.

In Example 89, the subject matter of example 87, wherein the film includes individual additional fourth layers being located between individual additional third layers.

In Example 90, the subject matter of example 87, wherein the film includes: a first set of layers that includes a number of first layers comprised of the first molecules alternating with a number of second layers comprised of the second molecules; and a second set of layers formed over the first set of layers, the second set of layers including a number of third layers of the third molecules alternating with a number of fourth layers comprised of the fourth molecules.

1.-65. (canceled)

66. An apparatus comprising:
a battery electrode material, having a coating comprising an organic compound, where the coating has a thickness of no greater than 100 nm,
wherein the coating comprises at least one layer having a backbone moiety and at least two functional groups coupled to the backbone moiety, the backbone moiety comprising (i) an alkyl chain having no greater than 8 carbon atoms, (ii) a cyclic aromatic hydrocarbon group, (iii) a fluorinated alkyl chain having no greater than 8 carbon atoms, (iv) one or more ether groups, or (v) a polymeric compound having a molecular weight no greater than 1 million Daltons (Da) and comprised of monomer units that include no greater than 10 carbon atoms.

67. The apparatus of claim 66, wherein:
a first functional group of the at least two functional groups includes a first electrophilic group or a first nucleophilic group and a second functional group of the at least two functional groups includes a second electrophilic group or a second nucleophilic group;
the first electrophilic group or the second electrophilic group includes a carbodiimide group, an isothiocyanate group, an isocyanate group, an acyl halide group, an ester group, anhydride group, chloroformate ester, ammonium, or a phosphonium group; and
the first nucleophilic group or the second nucleophilic group includes an amine, an alcohol, or a thiol.

68. The apparatus of claim 66, wherein:
the backbone moiety is coupled to a capping moiety;
the capping moiety includes an electrophilic group or a nucleophilic group;
the electrophilic group includes a carbodiimide group, an isothiocyanate group, an isocyanate group, an acyl halide group, an ester group, anhydride group, chloroformate ester, ammonium, or a phosphonium group; and
the nucleophilic group includes an amine, an alcohol, or a thiol.

69. The apparatus of claim 66, wherein the coating comprises:
a first layer of a plurality of layers includes a first backbone moiety and at least two first functional groups coupled to the first backbone moiety, the first backbone moiety comprising an alkyl chain having no greater than 8 carbon atoms, a monocyclic aromatic hydrocarbon group, a fluorinated alkyl chain having no greater than 8 carbon atoms, or one or more ether groups; and
a second layer of the plurality of layers includes a second backbone moiety and at least two second functional groups coupled to the second backbone moiety, the second backbone moiety comprising an alkyl chain having no greater than 8 carbon atoms, a monocyclic aromatic hydrocarbon group, a fluorinated alkyl chain having no greater than 8 carbon atoms, or one or more ether groups.

70. The apparatus of claim 69, wherein:
an intermediate layer is located between a substrate and the coating;
the intermediate layer is comprised of one or more compounds that include a first additional functional group to attach to the substrate and a second additional functional group to attach to the coating; and
the intermediate layer includes an additional organic compound comprised of an alkyl chain having no greater than 8 carbon atoms attached to the first additional functional group and the second additional functional group.

71. The apparatus of claim 70, wherein:
the first additional functional group includes a carboxylate group, a phosphate group, a halide group, halosilane, or a silicon alkoxide; and
the second additional functional group includes an alcohol, an amine, a thiol, an anhydride, or an isocyanate.

72. The apparatus of claim 71, wherein the additional organic compound includes 3-hydroxypropanoic acid, 2-hydroxyethyl dihydrogen phosphate, hydroxymethyltriethoxysilane, b-alanine, 2-aminoethyl dihydrogen phosphate, (3-aminopropyl)triethoxysilane (APTES), 4-(triethoxysilyl)aniline, (3-triethoxysilyl)propylsuccinic anhydride, 3-isocyanatopropyltriethoxysilane, 3-mercaptopropanoic acid, 2-mercaptoethyl dihydrogen phosphate, or (3-mercaptopropyl)trimethoxysilane (MPTES).

73. The apparatus of claim 66, wherein:
the coating comprises one or more layers with individual layers of the one or more layers including a number of instances of an organic compound;
one or more capping compounds are attached to at least a portion of the number of instances of the organic compound in an individual layer of the one or more layers; and
the one or more capping compounds include a hydroxyl group, an amine group, a thiol group, an acyl halide group, an ester group, an isocyanate group, an isothiocyanate group, a chloroformate group, an anhydride group.

74. The apparatus of claim 73, wherein the one or more capping compounds include benzylamine; propylamine; 2,2,2-trifluoroethyl amine; 2-methoxyethane-1-amine; phenol; benzyl alcohol; propanol; 2,2,2-trifluoroethanol; ethylene glycol monoethyl ether; benzoyl chloride; butyryl chloride; trifluoropropionyl chloride; 1-isocyanato-2-methoxyethane; furfuryl isocyanate; phenyl isocyanate; benzyl isocyanate; naphthyl isocyanate; cyclohexyl isocyanate; butyl isocyanate; 3,5-bis(trifluoromethyl)phenylisocyanate; 4-(trifluoromethyl)phenyl isocyanate; pentafluorophenyl isocyanate; mPEG-isocyanate; phenyl chloroformate; benzyl chloroformate; pentafluorobenzyl chloroformate; Fmoc-chloride; methyl chloroformate; butyl chloroformate; propyl chloroformate; pentyl chloroformate; 2,2,2-Trifluoroethyl chloroformate; 2-methoxyethyl chloroformate; vinyl chloroformate, allyl chloroformate; or propargyl chloroformate.

75. The apparatus of claim 66, wherein:
the coating is comprised of a number of groups of molecules coupled to a substrate; and
individual groups of molecules of the number of groups of molecules include a chain that includes one or more molecules, the chain extending away from the substrate.

76. The apparatus of claim 66, where the coating comprises one or more of the following organic compounds: phenylene diamine, melamine, 4,4′-oxydianiline; 4,4′-(1,4-phenylenediisopropylidene)bisaniline; emeraldine, leucoemeraldine, polypyrrole, poly(4-vinylpyridine), poly(4-vinylaniline); ethylene diamine; propylene diamine; diethylenetriamine; triethylenetetraamine; tetraethylenepentamine; pentaethylene hexamine; polyethyleneimine; polyallylamine; 3,5-bis(trifluoromethyl)phenylene-1,2-diamine; 2-(2-aminoethoxy)ethylamine; 2,2′-(ethylenedioxy)bis(ethylamine); 1,11-diamino-3,6,9-trioxaundecane; polyethyleneglycol amine terminated; hydroquinone, xylene-α,α′-diol; bisphenol P; bisphenol A; poly(4-vinylphenol); ethane-1,2-diol; propane-1,3-diol; glycerol; polyvinyl alcohol; polyallyl alcohol; 2,2,3,3-tetrafluoro-1,4-butanediol; hexafluoro-2,3-bis(trifluoromethyl)-2,3-butanediol; 1H, 1H,8H,8H-perfluoro-3,6-dioxaoctane-1,8-diol; diethylene glycol; dipropylene glycol triethylene glycol; polyethylene glycol; paraformaldehyde; polypropylene glycol; 1,3,4-thiadiazole-2,5-dithiol; benzene-1,4-dithiol; 1,4-benzenedimethanethiol; trithiocyanuric acid biphenyl-4,4′-dithiol; 1,2-ethanethiol; 1,6-hexanedithiol; 1,11-undecanedithiol; trimethylolpropane tris(3-mercaptopropionate); pentaerythritol tetrakis(3-mercaptopropionate); 2,2′-thiodiethanethiol; tetra(ethylene glycol) dithiol; poly(ethylene glycol) dithiol; terephthaloyl chloride, trimesoyl chloride; oxalyl chloride, succinyl chloride; polyacryloyl chloride; polymethacryloyl chloride; tetrafluorosuccinyl chloride; tetrafluoroterephthaloyl chloride; 2,2′-oxydiacetyl chloride; toluene 2,4-diisocyanate, 4,4′-diphenylmethanediisocyanate; poly[(phenyl isocyanate)-co-formaldehyde; hexamethylene diisocyanate; 4,4′-methylenebis(cyclohexyl isocyanate); poly(hexamethylene diisocyanate); 4arm-PEG-isocyanate; poly(propylene glycol)-tolylene 2,4-diisocyanate terminated; 1,4-phenylene bis(chloroformate); bisphenol A bis(chloroformate); ethylenebis(chloroformate); di(ethylene glycol) bis(chloroformate); tri(ethylene glycol) bis(chloroformate); 1,4-phenylene diisothiocyanate; tolylene-2,4-diisothiocyanate; 4,4′-diisothiocyanatodiphenylmethane; 4,4′-methylenebis(2-chlorophenyl)diisothiocyanate; butane-1,4-diisothiocyanate.

77. The apparatus of claim 66, wherein:
the organic compound comprises a polymeric compound comprised of a plurality of monomer units with individual monomer units comprising the backbone moiety; and
the individual monomer units include one or more glucose molecules or one or more glucose-derived molecules.

78. The apparatus of claim 77, wherein:
the individual monomer units include an alkyl chain having from 2 to 8 carbon atoms, the alkyl chain having an initial carbon atom and a terminal carbon atom; and
the initial carbon atom and the terminal carbon atom are individually substituted with at least one of a carbodiimide group, an isothiocyanate group, an isocyanate group, an acyl halide group, an ester group, anhydride group, chloroformate ester, ammonium, or a phosphonium group.

79. The apparatus of claim 66, wherein:
the organic compound comprises a polymeric compound comprised of a plurality of monomer units with individual monomer units comprising the backbone moiety; and
the individual monomer units include a monocyclic aromatic hydrocarbon having an aromatic ring comprising from 4 to 8 carbon atoms.

80. The apparatus of claim 79, wherein one or more carbon atoms of the aromatic ring are substituted with at least one of a carbodiimide group, an isothiocyanate group, an isocyanate group, an acyl halide group, an ester group, anhydride group, chloroformate ester, ammonium, or a phosphonium group.

81. The apparatus of claim 66, wherein:
the organic compound comprises a polymeric compound comprised of a plurality of monomer units with individual monomer units comprising the backbone moiety; and
the individual monomer units include an alkyl chain having from 2 to 8 carbon atoms, the alkyl chain having an initial carbon atom, a terminal carbon atom, and, optionally, one or more intermediate carbon atoms, and wherein at least one of the initial carbon atom, the terminal carbon atom, or the one or more intermediate carbon atoms are substituted with at least one halogen.

82. The apparatus of claim 81, wherein the initial carbon atom and the terminal carbon atom are individually substituted with at least one of a carbodiimide group, an isothiocyanate group, an isocyanate group, an acyl halide group, an ester group, anhydride group, chloroformate ester, ammonium, or a phosphonium group.

83. The apparatus of claim 66, wherein:
the organic compound comprises a polymeric compound comprised of a plurality of monomer units with individual monomer units comprising the backbone moiety; and
the individual monomer units include at least two ether groups with a first ether group of the at least two ether groups including an initial carbon atom and a second ether group of the at least two ether groups including a terminal carbon atom.

84. The apparatus of claim 83, wherein:
the at least two ether groups are linearly arranged and the at least two ether groups individually include from 2 to 8 carbon atoms; and
the initial carbon atom and the terminal carbon atom are individually substituted with at least one of a carbodiimide group, an isothiocyanate group, an isocyanate group, an acyl halide group, an ester group, anhydride group, chloroformate ester, ammonium, or a phosphonium group.

85. A method comprising:
providing a substrate comprised of a battery electrode material;
forming a first layer comprising a plurality of first molecules on the substrate, individual first molecules of the first layer being attached to the substrate and individual first molecules of the first layer comprising a first organic compound; and
forming a second layer comprising a plurality of second molecules on the first layer of molecules to form a film on the substrate, individual second molecules of the second layer being attached to one or more first molecules of the first layer, individual second molecules of the second layer comprising a second organic compound, and the film having a thickness no greater than 100 nanometers (nm).

86. The method of claim 85, wherein:
the first layer and the second layer are formed using one or more solution deposition techniques;
the first layer is formed by contacting the substrate with a first solution comprising a first solvent and a first precursor that corresponds to the individual first molecules; and
the second layer is formed by contacting the individual first molecules of the first layer with a second solution comprising a second solvent and a second precursor that corresponds to the individual second molecules.

87. The method of claim 86, wherein the first solvent and the second solvent comprise toluene, xylene, tetrahydrofuran, 1,4-dioxane, 1,2-dimethoxyethane, dichloromethane, chloroform, ethyl acetate, acetonitrile, N,N-dimethylformamide, dimethyl sulfoxide, or water.

88. The method of claim 85, comprising:
performing a cycle that adds a number of layers to the film, wherein the cycle includes:
forming an additional first layer including an additional plurality of first molecules on a base layer, the additional plurality of first molecules being individually attached to one or more molecules of the base layer; and
forming an additional second layer including an additional plurality of second molecules on the additional first layer, the additional plurality of second molecules being individually attached to one or more of the plurality of first molecules.

89. The method of claim 88, comprising:
repeating the cycle one or more times to add a number of layers to the film such that the film comprises multiple additional first layers comprising a number of first molecules and multiple additional second layers comprising a number of second molecules.
